(19) United States
(12) Patent Application Publication
(10) Pub. No.: US 2024/0043043 A1
(43) Pub. Date: Feb. 8, 2024

(54) VEHICLE SYSTEM AND METHOD

(71) Applicant: Transportation IP Holdings, LLC, Norwalk, CT (US)

(72) Inventors: James D. Brooks, Schenectady, NY (US); Timothy Brown, Erie, PA (US); Gnouma Diagana, Toronto (CA); Adam Franco, Melbourne, FL (US); David Furedy, Grove City, PA (US); Ken Kenjale, Indialantic, FL (US); Milan Karunaratne, Orange, CA (US); Brian Kurz, Germantown, MD (US); Chadwick Kypta, Pittsburgh, PA (US); Luke Leiter, Erie, PA (US); Brian Nedward Meyer, Fairview, PA (US); Aaron Nye, Philadelphia, PA (US); Anthony D. Paul, Erie, PA (US); David Petersen, Indialantic, FL (US); Robert Peipert, Melbourne, FL (US); Nicholas Savidge, Chicago, IL (US); Chris Schuchmann, Melbourne, FL (US); Derek Kevin Woo, Melbourne, FL (US)

(21) Appl. No.: 18/490,560

(22) Filed: Oct. 19, 2023

Related U.S. Application Data
(63) Continuation-in-part of application No. 17/489,923, filed on Sep. 30, 2021.
Application No. 17/489,923 is a continuation-in-part of application No. 17/237,686, filed on Apr. 22, 2021, now Pat. No. 11,834,023.
Application No. 17/237,686 is a continuation-in-part of application No. 17/585,719, filed on Jan. 27, 2022.
Application No. 17/585,719 is a continuation-in-part of application No. 16/722,281, filed on Dec. 20, 2019, now Pat. No. 11,270,130.
Application No. 16/722,281 is a continuation-in-part of application No. 15/651,067, filed on Jul. 17, 2017, now Pat. No. 10,558,865.
Application No. 15/651,067 is a continuation-in-part of application No. 17/203,466, filed on Mar. 16, 2021.
Application No. 17/203,466 is a continuation-in-part of application No. 17/532,522, filed on Nov. 22, 2021.
(60) Provisional application No. 62/371,609, filed on Aug. 5, 2016.
(60) Provisional application No. 62/993,274, filed on Mar. 23, 2020.
(60) Provisional application No. 63/122,701, filed on Dec. 8, 2020.

(51) Int. Cl. B60W 60/00; B60W 10/06; B60W 10/18

(52) U.S. Cl. CPC B60W 60/00256; B60W 10/06; B60W 10/18; B60D 1/36

(57) ABSTRACT

A vehicle system is provided that has an unoccupied control vehicle with no onboard driver. The control vehicle has a first propulsion system that can propel the control vehicle along a route, and optionally to stop or slow the control vehicle. One or more onboard power sources that can generate, store or both generate and store energy for powering at least the first propulsion system. A controller having one or more processors can autonomously control the propulsion system to move the control vehicle along one or more routes, and to interface with and couple to a driver-operable vehicle that has a second propulsion system. The controller can obtain control over the second propulsion system when the control vehicle is interfaced and coupled with the driver-operable vehicle.

### CROSS-REFERENCE TO RELATED APPLICATIONS

This application is a Continuation-In-Part of U.S. application Ser. No. 17/489,923, filed on 30 Sep. 2021, is a Continuation-In-Part of U.S. application Ser. No. 17/237,686, filed on 22 Apr. 2021, and is a Continuation-In-Part of U.S. application Ser. No. 17/585,719, filed on 27 Jan. 2022, which is a Continuation-In-Part of Ser. No. 16/722,281, filed on 20 Dec. 2019 (now U.S. Pat. No. 11,270,130), which is a Continuation-In-Part of U.S. application Ser. No. 15/651,067, filed on 17 Jul. 2017 (now U.S. Pat. No. 10,558,865), which claims priority to U.S. Provisional Application No. 62/371,609, filed on 5 Aug. 2016. This application is also a Continuation-In-Part of U.S. application Ser. No. 17/203,466, filed on 16 Mar. 2021, which claims priority to U.S. Provisional Application No. 62/993,274, filed on 23 Mar. 2020. This application also is a Continuation-In-Part of U.S. application Ser. No. 17/532,522, filed on 22 Nov. 2021, which claims priority to U.S. Provisional Application No. 63/122,701, filed on 8 Dec. 2020. Each of the above-referenced applications is hereby incorporated by reference in its entirety.

### BACKGROUND

### Technical Field

The subject matter described herein relates to a system for the movement of cargo and/or passengers through a transportation network.

### Discussion of Art

A transportation network for vehicle systems may include several interconnected routes on which separate vehicles travel between locations to deliver or receive cargo in the form of one or more payloads. The vehicles may travel according to schedules that dictate where and when the vehicles are to travel within the transportation network. The schedules may coordinate with each other to arrange for certain vehicles to arrive at various locations in the transportation network at desired times and/or in a desired order.

Payloads may be moved by plural transportation modalities. One example may be a railroad network, another may use marine vessels and/or on-highway trucks. Goods may be handed off from one modality to another during the course of a complete trip. Each modality may have delivery time variation based on aspects related to its equipment and operation. Variation in delivery times, as applied to rail transport, may occur from the making and breaking of trains, crew changes, terminal dwells, slow speeds of operation, and the like. Additionally, stops at rail yards, cargo depots, and the like, may create bottlenecks in the flow of the vehicles through a transportation network as vehicles wait at these locations for cargo to be loaded, cargo to be unloaded, vehicles to join together, vehicles to be separated from each other, vehicles to be refueled, and the like. Transloading cargo from one modality to another may be time-consuming. It may be desirable to have a vehicle system and method that differs from those that are currently available.

### BRIEF DESCRIPTION

In one embodiment, a vehicle system is provided that has an unoccupied control vehicle with no onboard driver. The control vehicle has a first propulsion system that can propel the control vehicle along a route, and optionally to stop or slow the control vehicle. One or more onboard power sources that can generate, store or both generate and store energy for powering at least the first propulsion system. A controller having one or more processors can autonomously control the propulsion system to move the control vehicle along one or more routes, and to interface with and couple to a driver-operable vehicle that has a second propulsion system. The controller can obtain control over the second propulsion system when the control vehicle is interfaced and coupled with the driver-operable vehicle.

In one embodiment, a vehicle system is provided that includes a controller. The controller can be at least partially disposed on a control vehicle (or may be entirely disposed onboard the vehicle) and has one or more processors. The controller can obtain at least one first operating parameter from a first sensor related to an operating system of a driver-operable vehicle. The controller can compare the at least one first operating parameter to an expected first operating parameter. An operating condition of the operating system can be determined based at least in part on the first operating parameter. In response to the at least one first operating parameter exceeding a determined threshold value related to the expected first operating parameter obtain at least one auxiliary operating parameter from a second sensor that is offboard the driver operable vehicle. The auxiliary operating parameter relates to the operating condition. The operating condition can be verified based at least in part on the first operating parameter and on the auxiliary operating parameter. The controller can control movement of the driver-operable vehicle responsive to verifying the operating condition of the operating system by changing one or more of a propulsion setting or a brake setting of the driver-operable vehicle.

In one embodiment, a controller for a vehicle system is provided. The controller can be at least partially disposed on a control vehicle (or may be entirely disposed onboard the vehicle) having an auxiliary sensor. The controller has one or more processors and can compare a first operating parameter of a driver-operable vehicle to an expected first operating parameter. The auxiliary sensor may be initiated to detect at least one auxiliary operating parameter responsive to determining that the at least one first operating parameter exceeds a determined threshold value related to the expected first operating parameter. An operating condition of the driver-operable vehicle may be verified based on both the first operating parameter and the auxiliary operating parameter. The controller can change one or more operating settings of the vehicle system to control movement of the vehicle system responsive to verifying the operating condition of the operating system.

### BRIEF DESCRIPTION OF THE DRAWINGS

The inventive subject matter may be understood from reading the following description of non-limiting embodiments, with reference to the attached drawings, wherein below:

FIG. 1A illustrates an example of a vehicle system according to an embodiment of the invention;

FIG. 1B illustrates an example of a vehicle system according to an embodiment of the invention;

FIG. 2 illustrates one example of a transportation network;

FIG. 3 illustrates an embodiment of a transportation network management system;

FIG. 4 illustrates an example of a movement schedule generated by the transportation network management system shown in FIG. 3; and

FIG. 5 illustrates a flowchart of an embodiment of a method for managing movements of vehicles in a transportation network to deliver cargo.

### DETAILED DESCRIPTION

One or more examples herein-described relate to a vehicle system, and an associated method of operating the vehicle system. The vehicle system may include a control vehicle that can selectively couple to a driver-operable vehicle and/or a cargo vehicle. Before discussing the control vehicle below, a suitable driver-operable vehicle may be a locomotive, an on-road truck, a marine vessel, and the like. These driver-operable vehicles may be powered for propulsion and generally can operate to move cargo or haul cargo vehicles. A cargo vehicle is non-self-propelled vehicle that accepts cargo (e.g., goods, people, etc.) and can be hauled from place to place by a driver-operable vehicle.

Also disclosed are associated methods for coordinating and managing the movement of cargo (goods and/or people) throughout a transportation network using the control vehicle. This may be accomplished, for example, by using self-propelling control vehicles. The control vehicle may move in the transportation network and may selectively couple with and provide energy, torque, power, propulsion, navigation, signaling and other functionality and/or information to and or about one or more driver-operable and/or cargo vehicles. In one embodiment, a suitable control vehicle may be a driverless vehicle, also referred to as an unoccupied control vehicle. By driverless or unoccupied, it is meant that in some embodiments an operator may be located offboard and/or by an autonomous controller onboard, rather than by a person. A cab to house an operator may be absent.

In various embodiments described herein, the systems and methods may provide a network of vehicle systems and how they can work together. In one example, they may be used for single or dual terrain micro-ton haulage, use fully autonomous vehicles and may seamlessly engage and coordinate with other customizable rail vehicle systems and automatic trucking vehicles as well as drayage haulers and the like. This may help railroads or fleet operators to improve the delivery efficiency, certainty, and convenience of moving intermodal goods with little to no disruption to the network via a movement as a service (MaaS). While the description herein focuses on the use of rail-based vehicles and vehicle systems (two or more vehicles traveling together, whether the vehicles are mechanically coupled or separate from each other) and the use of road-based vehicles and vehicle systems (e.g., trucks), the systems may involve combinations of other vehicular modalities. These other modalities may include marine vessels, manned and/or unmanned aircraft, mining vehicles, automobiles, etc.

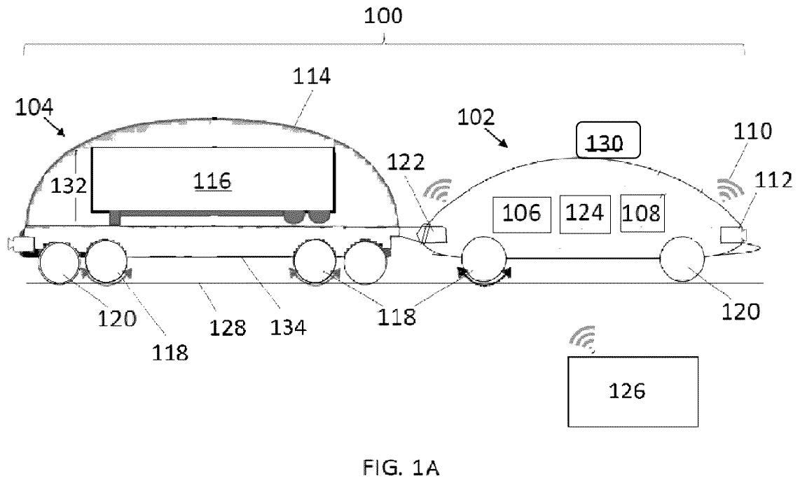

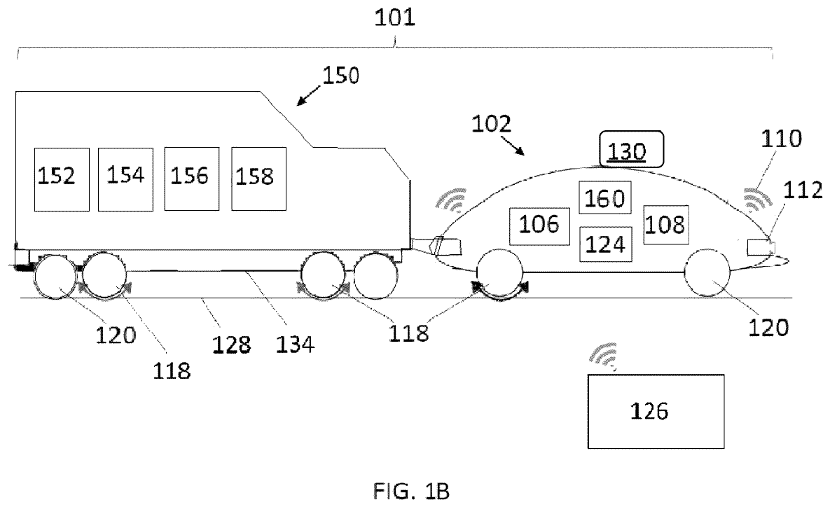

FIG. 1A illustrates an example of a vehicle system 100 according to an embodiment of the invention. The vehicle system includes a control vehicle 102 and a cargo vehicle 104. The control vehicle is a self-propelling vehicle. The vehicle systems include the control vehicle and the cargo vehicle. The control vehicles further include a power source 106, a vehicle controller 108, a propulsion system having at least one powered axle 118, optionally one or more unpowered axles 120, optionally a powered coupler 122, one or more wireless communication devices 124 (that send wireless signals 110 that may communicate with, for example, wayside equipment 126 disposed alongside a route 128), and at least one sensor 112, 130. The cargo vehicle may support a carried vehicle 132 on a platform 134 that may have a structure that defines an enclosure 114 for carrying the cargo.

FIG. 1B illustrates an example of a vehicle system 101 according to an embodiment of the invention. Similar to the system shown in FIG. 1A, a driver-operable vehicle 150 is selectively couplable to the control vehicle. The driver-operable vehicle includes a power source 152, a basic control system 154, a basic communication device 156, and an operator cab 158. In one embodiment, the basic communication device may be a wired device. In another embodiment, the basic communication device may be a wireless device. Regardless of being wired or wireless, the basic communication device on the driver operable vehicle may communicate at least with the control vehicle and may receive operational control signals therefrom.

An optional auxiliary support system 160 may be disposed on the control vehicle. The auxiliary support system may be selected and provisioned to provide various functionality to the control vehicle (and any other cargo vehicles that may be coupled thereto). Suitable functionality with which the control vehicle may provide to the driver operable vehicle may include compressed air, electricity to jump start a dead battery, electricity to crank an engine, electricity (or heat) to increase the temperature of an oil reserve or a fuel tank, communication pathways, event recorder data storage (including within crash hardened memory), video image storage, edge computing capabilities, and the like. Other suitable functionality may include one or more of sanding, snow removal, traction enhancement, track lubrication, wayside maintenance, and other related functions. Traction enhancement may be obtained through the use of the ARC Advanced Rail Cleaner system, which is commercially available from Wabtec Corporation. Wayside maintenance may be one of multiple activities, but vegetation control is specifically contemplated.

During operation, the operator cab of the driver-operable vehicle may be occupied or not occupied depending on the end use parameters. Of note is that via the communication devices, the control vehicle in at least some operating modes controls the driver-operable vehicle. In some instances, an operator of the driver-operable vehicle may be able to selectively take back command from the control vehicle, but regular operation has the control vehicle in charge of operating the vehicle system.

In one embodiment, the control vehicle's vehicle controller is capable of providing one or more functions for the control vehicle, and by extension to the whole of the vehicle group. These functions may include being the positive train control interface and providing the functionality of positive vehicle control (e.g., positive train control). Others may include being the wireless crossing interface and function, a forward looking video recording function, a track inspection interface and function (with a sensor package), distributed power interface and function, energy management and trip planning function, consist management (individualized power level control of plural powered vehicles in vehicle system consist), communication with an end-of-train (EOT) device, health diagnostics and/or prognostics for a driver-operable vehicle, self-diagnostics and prognostics (including status of functional cargo vehicles, such as refrigerated or sealed containers), collision avoidance, precision location and navigation capabilities (including asset and cargo tracking), switching and signaling interface and function, annunciation, and the like. In one embodiment, the control vehicle may identify the presence (or verify the absence) of people (and by extension, animals) in an area adjacent to the vehicle system. This function differs somewhat from a person identification function that detects if people are in the path of travel of the vehicle, as it is determining if there are people, and how many people, are in a determined region or area (nominally defined by the sensor's capabilities). In one use case, a control vehicle's sensor package may function to determine if unauthorized persons are in a work area—such as a rail yard—and may provide that data or even differentiate the sensed people from legitimate rail yard workers. While video cameras may be useful for this function, in at least one example the sensors are infrared cameras.

With the functionality provided by the control vehicle, an older model locomotive (or a newer model with damaged, missing or misconfigured equipment) may be capable of navigating a PTC enabled section of track despite itself not being PTC equipped. In such an instance, the control vehicle acts as a lead locomotive. And, in one operating mode the control vehicle switches to commanding the driver-operable locomotive (or all of the driver-operable locomotives if there is more than one in the vehicle system or train). In one example, if the driver-operable vehicle assumes a manual operating mode, rather than the control vehicle as master operating mode, the train of which it is a part may not be PTC compliant.

The vehicle controller may determine operation of the control vehicle, such as movement direction, movement speed, acceleration rate, braking application, turning rate, collision avoidance, fuel consumption rate, emission rate, and elevation (where applicable), among other things. A suitable controller may represent hardware circuitry that includes and/or is connected with one or more processors (e.g., one or more field programmable gate arrays, one or more microprocessors, one or more integrated circuits, etc.) that control operation of the control vehicle and/or the cargo vehicle. The vehicle controller may automatically control movement of the vehicle with input from on-board sensors (including onboard GPS receivers) and without input from off-board sensors (not shown) or directed input. Alternatively, the vehicle controller may control movement of the control vehicle based at least in part on input provided by an operator onboard the driver-operable vehicle, a wayside device, a remotely located operator, the operating system of another vehicle, a GPS signal, and the like. As another example, the vehicle controller may control movement of the vehicle based on input provided by an operator off-board the vehicles (e.g., using a remote control device). As another example, the vehicle controller may control movement of the vehicle based on input provided by a positive vehicle control system, such as a positive train control (PTC) system, such as the I-ETMS positive train control system that is commercially available from Wabtec Corporation. The control vehicle may be the repository of the route/track database and the interaction point with an off-board system to receive, and possibly validate, movement authority notices and bulletins.

In one embodiment, the control vehicle may switch operating modes in response to a determined trigger event. In one mode it may move under its own motive power. In another mode, while coupled to a cargo vehicle, it may move itself and the cargo vehicle. In another mode, it may couple to a driver-operable vehicle where it does one or more of: provide power to pull or push, drag along using dynamic braking to charge, signal for the vehicle system for purposes of interacting with the PTC system (or equivalent), and the like. In one mode the control vehicle may engage its energy management system (e.g., Trip Optimizer system) and initiate a trip plan, determine location on a route, control engine throttle on the coupled driver-operable vehicle's engine, and the like.

In one embodiment, the energy management system may determine that a control vehicle has insufficient charge to finish an entire trip. This may be because, for example, there are too many cargo vehicles, the cargo is too heavy, the grade/route is too steep in addition to being too far, charge in the energy device of the control vehicle is not at maximum or even if at maximum does not translate to sufficient milage, the weather is inclement, and the like. The energy management system may then determine that two control vehicles would have sufficient charge, and may cause them to couple and work as a single unit to have enough charge/mileage to get from the origin to the destination. The control vehicle may obtain locations for charging opportunities at chargers disposed on or proximate to the intended route of the vehicle system (or the control vehicle if acting for itself). The state of the charger may be obtained if the situation allows so that the control vehicle knows if it is occupied or not, operational or not, what is its voltage capabilities, how far to it, and does the control vehicle have sufficient charge to traverse the distance, and the like.

In one embodiment, command signals between the control vehicle and the driver-operable vehicle may be wireless in one embodiment, but may be wired (such as through the MU cable) in another embodiment. When communicating vehicle to vehicle, if there is a distributed power system the control vehicle may piggyback on that and communicate using the DP communications device. A suitable distributed power system is LocoTROL distributed power system, commercially available from Wabtec Corporation.

In one embodiment, the driver-operable vehicle may be providing propulsion in addition to or in place of the control vehicle. Should the engine be running, the alternator may provide enough electrical current to operate the control vehicle. By operating, that may mean one or more of the traction motors, the auxiliary equipment, and/or recharge the batteries (if present). Further, the charging can be from drag charging as the driver-operable vehicle provides all of the necessary propulsion, too. In this instance, the driver-operable vehicle may utilize the functionality of the control vehicle. The functionality could come from, for example, the PTC equipment onboard the control vehicle, wireless signaling systems, advanced vehicle optimization controls, track inspection data, snow blowing, track conditioning (sanding, or more likely the Advanced Rail Cleaner, commercially available from Wabtec Corporation), and the like.

In one embodiment, the vehicle control system may switch to a “self-park” or “auto-park” operating mode. In this mode, the control vehicle may obtain the location of a parking location (e.g., a siding, a shed), plot a trip from its current location to the parking spot, and traverse the route to arrive at the parking spot. Once arriving, the control vehicle may engage in one or more shut-down activities. These may include a power down process for the electronics to “off” or to a sleep mode, may engage a parking brake, may initiate a beacon, may communicate a last location signal, may de-energize circuits, may warm or cool various components, may purge fluids or gases (such as fuel), and the like. Upon a determined trigger the control vehicle may switch modes back to an operating mode, optionally through a wake up cycle.

In one embodiment, the control vehicle may have a “wake up and come to me” feature. In this, the vehicle controller may initiate an operating mode that identifies a target location and a current location. It may then plot a trip to traverse the distance from the current location to the target location and then execute the trip. The control vehicle will then travel to the target location and switch modes of operation again. In one related embodiment, an operator of an OCU RCL, such as that commercially available from Wabtec Corporation, the operator can initiate the ‘come to me’ function—by entering a code in the OCU or simply pressing a button—and the control vehicle will move to a section of the route nearest to the operator, while obeying safety rules and switching signals. In a variation, the control vehicle may have a “go home” or a “go charge” or a “go to repairs” operating mode. In each instance, the operating mode of the control vehicle switches and triggers a traversal to a determined location. For embodiments where the control vehicle has plural wheel types (i.e., a Hi-Rail capability) the control vehicle may determine a trip via one type of route or another (i.e., rail tracks or road) or both.

At least one embodiment of the control vehicle may have a relatively low profile or height to allow an operator of a driver-operable vehicle (such as a locomotive) to see over the control vehicle while the two vehicles are coupled together. Alternatively, a video array with a camera mounted on the control vehicle and a video display in the cab of the driver-operable vehicle may allow the operator to see what is in front of the vehicle system.

In one embodiment, at least the control vehicle has one or more automatic couplers. These couplers may be engaged to couple the control vehicle to the driver-operable vehicle, the cargo vehicle, or both. For on-road embodiments, the automatic coupler may function as a king pin, an automatic trailer hitch, and the like. The automatic coupler may detect, and optionally signal, a successful coupling. The automatic coupler may be operated to uncouple, too.

Sensors associated with the couples may function as a coupler monitoring device. The monitoring device may determine if the coupler is in one or more different states. The different states may indicate whether the monitoring device is coupled with a vehicle system or is not coupled with a vehicle system; whether the monitoring device is coupled to a vehicle at all, to which vehicle the monitoring device is coupled, whether the coupler is open or closed, whether the coupler is in a state other than open or closed (i.e., partially open or jammed), whether the coupler (having an actuator) is functioning properly, and the like. In one example, sensor signals generated by sensors of the monitoring device may be correlated via the controller with sensor signals generated by sensors of the vehicle system. The controller may determine that the monitoring device is affixed onboard and/or coupled with both the control vehicle and the driver-operable vehicle, based at least in part on the correlated sensor signals. Alternatively, the controller may determine that the monitoring device (if selectively removable) is not onboard a vehicle system based on correlated sensor signals. The controller may actuate the coupler so as to couple with, or release, another vehicle (driver-operable, cargo, etc.) for which the control vehicle is responsible.

In one embodiment, the control vehicle can (directly, or with the assistance of other equipment) switch the physical status for equipment on the other driver-operable and/or cargo vehicles. In various embodiments, suitable equipment may be a brake lever, such as to release brakes (e.g., handbrakes), a compressed air line, an electrical or communication coupling, and the like. So equipped, the control vehicle controller may operate in a mode to assemble a train by identifying or locating, traveling to, and actuating a coupler to secure a mechanical connection with a driver-operable vehicle. Optionally, the controller may then initiate one or more of connecting to a compressed air pipe, electrically couple to a plug/receptacle, and switch the condition of a brake handle from ‘brake’ to ‘not brake’.

The control vehicle can communicate with, and integrate into, a vehicle network management system in one embodiment. A suitable network management system may be, as examples, Yard Planner system or Movement Planner system, both of which are commercially available from Wabtec Corporation. During operation, the network management system may determine and direct one or more control vehicles to certain locations, may create consists or trains containing one or more control vehicles, and may cause the control vehicle and/or train or consist to navigate and traverse a network.

The vehicle controller may include one or more communication devices. Suitable devices may wirelessly communicate (e.g., via wireless communication signals) with each other, with corresponding devices disposed on other, different vehicles, with an off-board hand-held device, with a network management system, with a wayside device, with a signaling system, and the like. The hardware of the communication devices may include antennas, modems, transceiving hardware, a power source, etc. In one embodiment, the controller may wirelessly communicate with wayside equipment. Suitable wayside equipment may include traffic signals, crossing systems, inspection systems, balise beacons or navigation systems, positive train control (PTC) systems, and the like. Communication may allow the controller to be aware of current conditions of routes upon which the vehicle system may travel, locations of other and different vehicles, movement directions of those vehicles, occupancies of routes, speeds of those vehicles, etc. For example, the controller may determine whether an upcoming segment of a route is under repair, is occupied, contains an obstacle or is otherwise unavailable for travel by the vehicle based on signals received from wayside devices. As another example, the communication device(s) may communicate with other vehicles to obtain and/or provide information on the conditions of previous or upcoming portions of the route (e.g., weather, presence of damage or another vehicles, etc.). The controller may use this information obtained from wayside equipment, another vehicle, or other off-board locations (e.g., the management system) to determine which routes and/or portions of routes may be traveled upon to reach one or more locations within a designated period of time and/or no later than a scheduled time. For example, responsive to receiving at least some of this information, a vehicle may automatically change which routes are traveled upon to reach a location to avoid a damaged and/or occupied route.

The vehicles may include sensors to assist the controller and/or the operator(s) with controlling movement of the control vehicle. The sensor may represent one or more coupled sensors that are onboard the vehicle and remain onboard the vehicle during operation of the vehicle (and may not move relative to the vehicle during operation of the vehicle). The coupled sensors may include cameras, radar systems, LiDAR systems, and the like, that output information representing the surroundings of the vehicle. The sensors may be one or more mobile sensors capable of moving relative to the vehicle during operation of the vehicle. For example, the sensor may be coupled to an aircraft (e.g., an unmanned aerial vehicle or drone) such that the drone carries a camera, radar system, wind gauge, thermometer, and the like, and may fly ahead of, along the side of, behind, over or whatever relative to the control vehicle to obtain information on conditions proximate to the control vehicle. As the control vehicle, in one embodiment, can leave a rail track via road wheels, drive off track, and then return to the railroad track, a control vehicle with the mounted sensors can facilitate a mobile sensor relative to the vehicle system associated with the selectively decouplable control vehicle.

In one embodiment, the control vehicle hosts a sensor package that inspects objects and infrastructure adjacent or proximate to it. Signals from the sensor may facilitate the controller to detect determined features in a route being traveled by a vehicle. Example determined features may be selected with reference to the end use application, and may include misalignments, cracks, potholes, debris, loose or missing spikes, standing water or snow drifts, or other hazards. As an example, expanding on the misalignments, these may be thermal misalignments or sun kinks detected from a system onboard a moving vehicle. This allows the misalignments to be detected and one or more responsive actions initiated or implemented before the misalignments can present hazards to one or more vehicles subsequently traveling over the same segment of the route. One or more embodiments of the systems described herein can be disposed onboard the control vehicle. Plural control vehicles may be associated with a vehicle system, with a lead and a tail (relative to a direction of travel). The tail control vehicle may monitor segments of the route that were recently traversed by the lead control vehicle. Additionally or alternatively, the lead control vehicle (e.g., along the direction of travel) may monitor upcoming segments of the route that are yet to be traversed by the tail control vehicle (to allow responsive actions to be implemented or triggered prior to worsening the misalignment for one or more subsequent vehicle systems).

Embodiments described herein may identify, measure and/or monitor route features, such as curvatures of a track. As such, a suitable route may be a track formed from one or more rails. One or more embodiments may be useful for non-rail vehicles traveling on routes that may curve or become misaligned, such as automobiles or mining vehicles traveling along routes if such routes are partially washed out or otherwise damaged, high rail vehicles traveling on roads, etc.

As another example, the monitoring function of the controller may generate and communicate a signal to the output device to direct the output device to communicate a signal to other control vehicles heading toward and/or scheduled to travel over a hazard or defect to automatically and remotely control the other control vehicles to change routes to avoid traveling over the hazard or defect. Optionally, the monitoring function of the control system may generate and communicate a signal to the communication device to direct the communication device to communicate a signal to one or more route devices (e.g., switches, gates, etc.) that control where vehicle systems travel on the route that automatically and remotely controls the route device(s) to cause the other control vehicles to travel on other routes (e.g., change a state of a switch to cause other control vehicles to travel around and not over the hazard).

The monitoring function of the control system may generate and communicate a signal through the communication device to signal to a scheduling or dispatch facility to cause the schedule of one or more other vehicles to be changed to cause them to not travel over the hazard. Optionally, the monitoring function of the control system may generate and communicate a signal via the communication device to one or more repair personnel that causes the personnel to travel to the location of the hazard and inspect and/or repair it.

The sensor may include or be connected with the communication device to wirelessly communicate the information back to the control vehicle. In one embodiment, the controller may examine the information received from the sensors, and combined with an operating parameter and an auxiliary parameter, may control movement of the vehicle system. For example, the controller may use the information received from the sensors to ensure that the control vehicle maintains a safe stopping distance (e.g., at least a minimum braking distance) from another vehicle or objects/obstructions in the route, that the vehicles travel around obstructions or otherwise avoid collisions with other objects, that the vehicles travel along healthy and/or unoccupied routes (or change lanes for routes with plural lanes), that the vehicles avoid traveling through adverse weather conditions, that the vehicles avoid traveling through congested areas or portions of the route, etc.

One or more of the sensors may sense characteristics of the cargo being loaded onto the vehicle. For example, suitable sensors may include a camera that obtains an image of the cargo or a label on the cargo, a radio frequency identification (RFID) scanner that interrogates an RFID tag on the cargo, a receiver that wirelessly receives a signal emitted by a beacon or transmitter associated with the cargo, and the like. The characteristics of the cargo may include alpha- and/or numeric-text strings, data signals, or other information that identifies the cargo, where the cargo is to be transported, when the cargo is to be transported (e.g., a scheduled delivery date and/or time), etc. The controller may obtain this information from the sensors to determine how to deliver the cargo. For example, the controller may determine routes to travel upon, where and/or how far the vehicle is to remain connected with the vehicle to power the vehicle to deliver the cargo, and the like, based on the cargo information. The controller may then control movement of the vehicles according to these determinations to get the cargo to the target or delivery location within the specified time.

In one embodiment, the on-board sensor may detect a first operating parameter associated or related to an operating system of the control vehicle and/or the driver-operable vehicle. The operating system may include a braking system, propulsion system, wheel bearing system, communication system, heating system, cooling system etc. In one embodiment, the first operating parameter is a status of an automatic coupler. Suitable coupler status may be open/uncoupled and closed/coupled. Another first operating parameter may be the status of a communication device such that an authenticated and stable connection is established between the control vehicle and the driver-operable vehicle. Each operating system has, as a function, an aspect in the movement and operation of the vehicle. Other suitable first operating parameters may include temperatures, pressures, forces, speeds, rotational speeds, velocities, accelerations, temperature increases, decreases, and changes, pressure increases, decreases, and changes, or the like. In one example the first operating parameter may be whether a start up sequence of steps has completed such that a vehicle is ready to operate. In one example, the on-board sensor detects the pressure in an air feed device of the braking system. In another example, the on-board sensor may be a temperature sensor that detects the temperature of the grease in a bearing case. Alternatively, on-board sensor may be a float that detects the oil level in a bearing case. In yet another example, the on-board sensor may be a sensor that detects the rotational speed of a drive shaft.

In each example, the on-board sensor detects a first operating parameter that may be used to determine if an operating condition is present in a determined range and or relative to a threshold level. For example, the pressure in the air feed system, including changes in pressure may be used to determine the potential for faulty brakes, a leaking brake line, a cut or disconnected hose, and the like. The temperature of the grease in a bearing case, or the oil level in the bearing case may be indicative of a hot axle. Meanwhile, the rotational speed of the drive shaft may be indicative of an overheating or malfunctioning engine. In another example, the first operating parameter may indicate that the operating system is good to go and ready to operate in a nominal manner.

The control system may utilize sensors, or otherwise, to obtain operating parameters. These operating parameters may relate to a control vehicle's operating system during a trip. A determination can then be made based on an expected operating parameter whether an operating system is performing adequately, or not. If not, then potential maintenance may be needed or the operating of the control vehicle may need to be adjusted to compensate. If it is, then the vehicle system may be moved according to a trip plan. And, in one embodiment, operating system may be verified using an auxiliary parameter obtained from an offboard, second sensor. In particular, based on data related to a trip plan and an operating parameter (e.g., expected temperatures, pressures, fluid levels, etc.) verified using an auxiliary parameter, the operating system performance and/or health may be determined for any given time or distance of the trip. The obtained operating parameter may be compared to the expected operating parameter, and if a determined threshold value is exceeded, an operating condition may present that indicates a malfunctioning operating system (or potentially so).

To verify the operating condition (whether it indicates a malfunctioning operating system or a functioning operating system) the control system may communicate with an off-board sensor to obtain an auxiliary or second operating parameter. The auxiliary operating parameter may be used to determine and/or verify the operating condition of the control vehicle and/or the driver-operable vehicle.

The auxiliary operating parameter may then be communicated to the controller for such determination and verification. In this manner, a diagnosis of the operating condition may be made as the control vehicle is directing the vehicle system to traveling along the route. And, it may be communicated to a remote off-board controller such as a depot controller or maintenance controller. The control system may determine remedial actions accordingly. In this manner, maintenance may be scheduled before the vehicle even reaches a next stop, speeding maintenance cycle time. Additionally, such diagnosis may be provided to an inspector, such that extra care may be undertaken by the inspector, reducing the chance of human error.

A suitable off-board auxiliary sensor may be located adjacent to the route. Specifically, the off-board sensor may be considered adjacent to the route when placed in a position where the off-board sensor can obtain and detect operating parameters related to the vehicle on the route. For example, in an example when the off-board sensor is a camera, the camera may be adjacent to the route when the field of view of the camera captures one of the route or the vehicle system on the route. Similarly, in an example when the sensor is an infrared camera, or a hot box sensor that can determine the temperature of a component of an operating system, the sensor may be adjacent the route when such detection of the vehicle can be accomplished. To this end, the off-board sensor may be a video camera, infrared sensor, acoustic sensor temperature sensor, accelerometer, vibration sensor, motion sensor, hot box detector, vehicle identification scanner, lidar device, pressure sensor, or the like.

In one example, if the on-board sensor detects that the air pressure in the braking system drops below a determined threshold value pressure, an indication of an operating condition of poor brake performance may be determined. To verify the operating condition, the controller may obtain from the off-board sensor an auxiliary operating parameter of a temperature reading of the vehicle wheels as the vehicle system passes by the off-board sensor. The auxiliary operating parameter of the wheel temperatures may then be communicated to the controller that can determine a cold wheel. Specifically, if the temperature of a wheel in question is below a temperature threshold, verification may be provided that poor brake performance may be presented. In this manner, a diagnosis of poor brake performance may be determined while the vehicle system is still on the route. As such, the diagnosis, along with suggested remedial actions can be communicated to the vehicle system operator, communicated to a remote maintenance controller, communicated to a remote depot controller, etc. With the controller making a diagnosis using the off-board sensor, scheduling, rearranging of timing, prescribing another inspection at a specific drive-thru inspection station etc. can begin while the vehicle system is still on the route. As an additional example, an initial reading may be inconclusive, nearing a range of intolerance, or the like such that a follow up inspection to confirm or deny the condition may be present. In yet another example, a first inspection station may not be equipped to make the type of inspection based on the diagnosis, as a result, the remedial action may be to skip or pass up a first inspection station in favor of a second inspection station that has the equipment and capabilities to provide a sufficient inspection. To this end, the information gathered for making the initial diagnosis, along with the diagnosis, reading that may be nearing a range of intolerance, initial reading, or the like, can be passed along to an inspector to prevent the inspector of the vehicle system from overlooking the operating condition, thus reducing or eliminating human error.

In one example, the off-board sensor may be an off-board hot box detector. The off-board hot box detector may be positioned adjacent a route to determine a temperature related to an axle of the vehicle system. In this manner, if an on-board sensor may be a temperature sensor in a gearbox that detects and increase in temperature above a temperature threshold value, the controller can communicate with the off-board hot box detector to take temperature readings associated with the wheels. The off-board hot box detector may be an infrared sensor, temperature sensor, or the like. The off-board hot box detector may detect the temperature of a gear casing of an axle, the bearing temperature of an axle, a fluid temperature of lubricant of the axle, or the like. This detected temperature may then be communicated back to the controller that verifies a hot axle may be presented, and that maintenance may be required. Such verification may be determined utilizing an algorithm, mathematical function, lookup table, decision tree, artificial intelligence model, or the like. In addition, depending on where on the route the vehicle system is at, the controller may provide recommendations related to reducing the speed of the vehicle system, or even stopping a vehicle system to prevent or reduce damage to an axle. In this manner, remedial measures may be communicated to the control vehicle system that save time and costs.

Where the first operating parameter is obtained from a first sensor onboard the driver-operable vehicle, in one embodiment the auxiliary operating parameter may be obtained from a second auxiliary sensor disposed on the control vehicle (and, thus, off-board the driver-operable vehicle). For example, the control vehicle may not be constrained to the route as the driver-operable vehicle such that it can leave the track on road wheels or navigate a switch to a parallel track and drive alongside the vehicle system (which may be moving slowly or be parked). As the control vehicle encounters the driver-operable vehicle the second sensor may obtain the auxiliary operating parameter. In practice, for example, the driver-operable vehicle has a first sensor that indicates that the compressor is seized up; and, the control vehicle has an acoustic second sensor that can determine if a compressor is operating where the control vehicle maneuvers to be adjacent to the driver-operable vehicle, commands the compressor to operate, and monitors the second sensor for the sound of an operating compressor. As another example, the control vehicle can command the traction motors to push the coupled control vehicle, and the second sensor may determine a rate of movement of the control vehicle wheels.

In an embodiment, the controller may obtain a vehicle characterization element. The vehicle characterization element may provide data about the make-up of the control vehicle, and the vehicle system with which it is associated, such as the type of cargo vehicles (for example, the manufacturer, the product number, the materials, etc.) the number of cargo vehicles, the weight of cargo vehicles, whether the cargo vehicles are consistent (meaning relatively identical in weight and distribution throughout the length of the vehicle system) or inconsistent, the type and weight of cargo, the total weight of the vehicle system, the number of driver-operable vehicles, the position and arrangement of driver-operable vehicles relative to the cargo vehicles, the type of driver-operable vehicles (including the manufacturer, the product number, power output capabilities, available notch or throttle settings, fuel usage rates, etc.), and the like. The vehicle characterization element may be a database stored in an electronic storage device, or memory.

The control vehicle may use the vehicle characterization element in the use of the propulsion system, to include braking. This element may be combined, in one embodiment, with information from offboard sensors, such as cameras disposed in a wayside device. The data combination may be used to adjust speed and calculate stopping distance, such as, for example, if a crossing is obstructed. The control vehicle signals to the driver-operable vehicle may initiate a switch in operating modes of the driver-operable vehicle. It may, for example, increase or decrease the throttle of an engine on the driver operable vehicle.

In one embodiment, the control vehicle is a vehicle that is relatively smaller than currently used freight locomotives, relatively more aerodynamic than currently used freight locomotives, battery powered, self-propelling, and fully automatic/autonomous vehicle that may propel itself along a route that is defined by railroad tracks. By smaller, it is meant to have less volume relative to a standard freight hauling vehicle, or has less horsepower, or both. The control vehicle may be a rail vehicle having one or more steel wheels, onboard controllers, cooling systems, braking systems, propulsion systems (e.g., traction motors that work with the braking systems), power electronics (e.g., circuitry that controls conduction of current from the power sources to the systems powered by the stored electric energy), communication systems (e.g., transceivers, transmitters, receivers, antennas, modems, etc., of the controller), the power sources, edge processing hardware circuitry (e.g., which may be part of the controller), sensing hardware circuitry (e.g., the sensors), vehicle to vehicle interaction system, and the like.

A suitable power source may be an energy storage device and may power one or more traction motors for propelling the vehicle, and/or to supply an auxiliary load for more than bare functionality or for more than a short while. The energy storage devices may be coupled to a dynamic braking system to charge in response to a dynamic braking event using traction motors. Examples of suitable energy storage devices include batteries. Suitable batteries may include a lithium ion cell array, a sodium metal halide cell array, a sodium sulfur cell array, a nickel metal hydride cell array, redox flow battery, and a nickel cadmium cell array. Optionally, one or more of the power sources may be fuel converters, which may need a fuel tank that can hold a liquid and/or gaseous fuel that is consumed by an engine that works to propel the vehicle. Examples of suitable fuel may be predicated on the engine type, but can include gasoline, diesel, natural gas, compressed air, hydrogen, ammonia, dimethyl ether, alcohol, and the like.

The control vehicle may generate at least enough tractive effort to self-propel itself. In some embodiments, the control vehicle may not be capable of generating enough tractive effort to move the driver-operable vehicle and all the coupled cargo vehicles (with or without cargo) along the routes. The control vehicle may be a carrier of power source that may be the limiting factor of how much horsepower the control vehicle can generate, in some cases its limited by the size of the traction motors. During operation, the control vehicle traction motors may provide horsepower in a range of from about 500 HP to about 1000 HP, in a range of from about 1001 HP to about 2000 HP, in a range of from about 2001 HP to about 2500 HP, in a range of from about 2501 HP to about 3500 HP, in a range of from about 3501 HP to about 4500 HP, in a range of less than about 4,500 horsepower, and in a range of greater than about 4501 HP, each selected based at least in part on end use requirements. In one embodiment, the motors of the control vehicle may not be capable of producing enough horsepower to propel cargo, such as cargo weighing 10,000 pounds or more. The selection of the amount of horsepower is predicated on multiple factors. These factors may include the amount of available space (with larger power sources and larger traction motors requiring more space), overall weight (with higher HP comes higher weight, cost, desired efficiency, speed, and the like. The control vehicle, depending on its end use, may have strict requirements for size (height, width, length, ground clearance, and the like), weight (which is an input in the amount of available tractive effort on top of being limited by route capabilities), and the like. The amount of dynamic braking may be determined at least in part by the sizing of the traction motors, the c-rate (charging uptake rate) of the energy source, and the like. Note that in one possible configuration, with a control vehicle coupled to a powered driver-occupied vehicle, it may be desirable to provide visual line of sight in the direction of travel to the operator of the driver-operable vehicle and as such the control vehicle may be height limited.

The controller of the control vehicle may monitor operations of the vehicle and/or the vehicle to determine when maintenance or inspection of the vehicle is needed. For example, the sensors may include thermocouples, infrared sensors, accelerometers, pressure sensors, ammeters, or other sensors, that monitor temperatures, pressures, vibrations, states of charge, magnitudes of electric current being conducted, and the like, and may determine whether operation of one or more systems onboard the vehicle and/or the vehicle is declining or otherwise indicates that repair or inspection is needed. The controller may then automatically control the vehicle to move to a location where the repair or inspection occurs, may send a signal to a second vehicle to replace or assist the vehicle needing inspection or repair, may send a signal to a third vehicle to bring another vehicle to replace or assist the vehicle in carrying the cargo to a location, and the like.

The cargo vehicle may include the platform and, optionally, a structure that defines the enclosure in which cargo may be carried. In the illustrated embodiment, the cargo is a storage container, such as a trailer in which materials, product, livestock, etc., is carried. Optionally, the cargo may represent persons, such as a car having seats for people to sit in during travel. As shown, the exterior surfaces of the control vehicle and the enclosure may have rounded shapes that reduce wind resistance relative to other less rounded shapes. This may allow the vehicles to reduce electricity and/or fuel consumption during travel. Optionally, the control vehicle may carry at least some of the cargo. In one embodiment, the control vehicle does not carry any of the cargo.

With regard to the propulsion systems, in one embodiment, it may be a powered wheel-axle set having one or more traction motors. The wheel-axle set includes an axle that connects two wheels with the axle being rotated by the traction motor(s) to rotate the wheels (and thereby propel the vehicle). Optionally, the propulsion system may represent the one or more traction motors and a wheel (or set of wheels) that are rotated by the traction motor(s) to propel the vehicle. The traction motors may be powered by the electric energy provided from the power source. Alternatively, the traction motor may be powered by an alternator or generator that is rotated by an engine that consumes fuel from the power sources. In the illustrated embodiments, the cargo vehicle has two or more powered axles and the control vehicle has fewer, at one powered axle.

The vehicle optionally may include one or more unpowered axles. An unpowered axle may be an axle that is not torqued or rotated by a traction motor connected with the axle by one or more gears and/or a wheel that is not rotated by a traction motor connected with the wheel by one or more gears. The unpowered axles may only rotate due to movement of the vehicles caused by rotation of the powered axle(s). In one embodiment, the control vehicle includes at least one propulsion system and at least one power source. In another embodiment, the control vehicle includes at least one power source but the vehicle does not include any powered axles, only unpowered axles.

In the illustrated embodiment, the cargo vehicle includes more powered axles than the control vehicle. As a result, the cargo vehicle may be able to generate more tractive effort or propulsive force to propel the cargo vehicle (and/or a vehicle system that includes the vehicle) than the control vehicle. The greater number of powered axles may be provided in the cargo vehicle instead of the control vehicle because the load (e.g., weight or mass) carried by the cargo vehicle may be substantially greater than the load carried by the control vehicle. This increased load may increase the tractive effort generated by the powered axles in the cargo vehicle. Stated differently, the control vehicle may be substantially lighter than the cargo vehicle and, as a result, not generate as much tractive effort or propulsive force as the cargo vehicle.

The vehicles may be connected with each other by the powered coupler 122. The coupler is or includes a conductive connection between the power sources in the control vehicle and the powered axles (that is, the motors represented by the powered axles) in the cargo vehicle. In this way, the control vehicle provides the electric energy consumed by the powered axles in the cargo vehicle for the cargo vehicle to propel itself along routes. The coupler may include cables, wires, buses, and the like, for conductively coupling the power sources on the control vehicle with the powered axles of the cargo vehicle. During use, the coupler may mechanically couple the vehicles with each other so that propulsion generated by the cargo vehicle may push or pull the control vehicle along the routes. Simple traditional couplers may be used in one embodiment.

The coupler may include one or more conductive connections that allow for the controller of the control vehicle to communicate with one or more sensors onboard the cargo vehicle. Optionally, the cargo vehicle may alternatively or additionally include a communication device that wirelessly communicates with the controller of the control vehicle; in one embodiment, the two vehicles can communicate with one another by way of both wired and wireless connections. Optionally, the cargo vehicle may include a tangible and non-transitory computer-readable media, such as a computer memory, that stores historical information about the cargo vehicle. The information obtained by the sensors and/or stored in the memory of the cargo vehicle may be communicated to the controller of the control vehicle upon coupling of the vehicles to each other. This information may be used by the controller to determine how to move the vehicle. For example, information about historical usage, maintenance, and/or repairs of the cargo vehicle may be used by the controller to determine how quickly to move the cargo vehicle, how much energy to supply to the cargo vehicle, how far the cargo vehicle may travel (e.g., before repair or maintenance is needed), and the like.

One or more additional sensors (not shown) may be disposed onboard the cargo vehicle to provide the controller of the control vehicle with information about the surroundings and/or locations ahead of the vehicles. As described above, this information may be used by the controller to dictate how and/or where the vehicles move to transport the cargo.

In one embodiment, the vehicle and/or the vehicle may be a multi-terrain vehicle capable of moving over different types of routes. For example, the vehicles may include two or more sets of wheels connected to axles, with one set of wheels shaped and positioned to travel on rails of a track as the route, another set of wheels shaped and positioned to travel on a road as the route, and/or another set of wheels shaped and positioned to travel on another surface (the ground but not on a paved road). The control vehicle may lift one wheel set to pull off of rails or track and travel on roads to a destination. Optionally, the vehicle and/or the vehicle may have a marine propulsion system and may be able to float on water, with the marine propulsion system propelling the vehicle and/or the vehicle. The multi-terrain type of vehicle may allow for the vehicles to complete the last portion of delivery of cargo (e.g., the last-mile of delivery of cargo). For example, the vehicle may be part of a train traveling along a track that stops at an intersection or crossing between the track and a road. The vehicle may be decoupled from the train and couples with the vehicle for travel along the road to a destination location of the cargo.

The cargo vehicle may not include any power sources onboard the cargo vehicle. The cargo vehicle may rely on current from the power sources to power the powered axles of the cargo vehicle. In such an embodiment, the cargo vehicle may be incapable of propelling itself without being coupled with an external (e.g., off-board) power source, such as the control vehicle. Alternatively, the cargo vehicle may include one or more onboard power sources to at least partially power the motors of the powered axles. These onboard power sources of the cargo vehicle may not be capable of storing enough energy to power the axles of the cargo vehicle to reach a destination of the cargo, but may store enough energy to power the axles to move the cargo vehicle short distances, such as one hundred meters or less, to position the cargo vehicle for loading of cargo, unloading of cargo, coupling with the vehicle, and the like.

The cargo vehicle may be connected with a vehicle other than the control vehicle. This other type of vehicle may supply power to propel the cargo vehicle. This other type of vehicle may be a vehicle that is propelled (and that pushes or pulls the cargo vehicle) using fuel such as gasoline, diesel fuel, liquid natural gas, and the like.

In one embodiment, the cargo vehicle may be capable of conveying the at least one carried vehicle (e.g., on-road trailer, an intermodal container) that is, itself, carrying cargo. For example, the cargo shown in FIG. 1a may be disposed onboard a trailer pulled by a truck, onboard a rail car, and the like. The carried vehicle may be transferred onto the cargo vehicle by a truck, locomotive, crane, and the like. Optionally, the cargo vehicle may include an onboard motorized lift, crane, or other equipment to automatically place the carried vehicle onto and/or off the cargo vehicle.

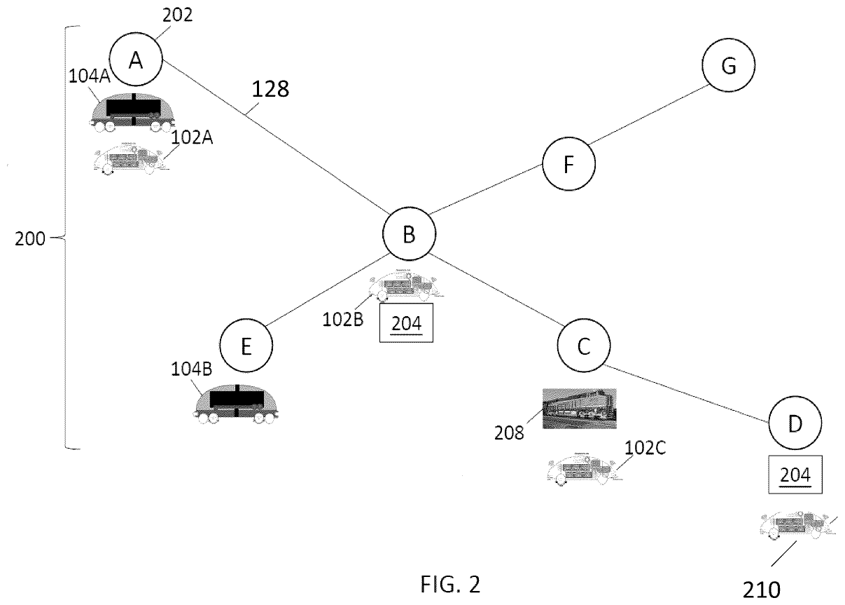

FIG. 2 illustrates one example of a transportation network 200. The network may be formed by several routes that connect or intersect with each other at various locations 202 (e.g., locations A-G in FIG. 2). The locations may represent vehicle yards, rail sidings, route intersections, garages, and the like.

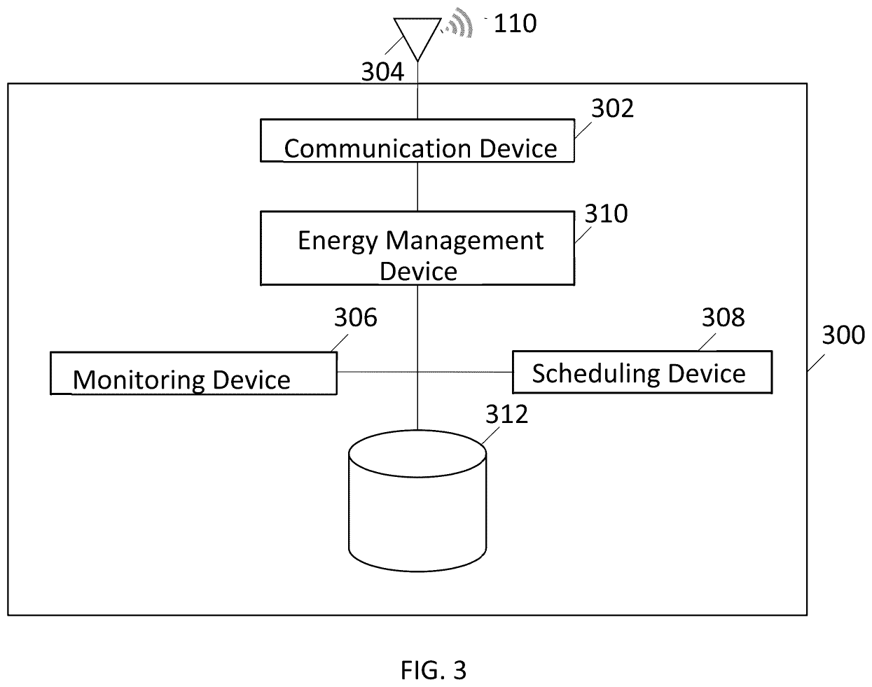

With continued reference to the transportation network shown in FIG. 2, FIG. 3 illustrates an embodiment of a transportation network management system 300. The management system has one or more computerized devices that may perform the operations described herein. In one embodiment, the management system is disposed off-board the vehicles and communicates with the vehicles as described herein. Optionally, part or all of the management system is disposed onboard at least one of the vehicles (e.g., within the controller).

The management system may include several devices having hardware circuitry that includes and/or is connected with one or more processors (e.g., one or more microprocessors, one or more field programmable gate arrays, one or more integrated circuits, and the like). The circuitry and/or processor(s) for each device may be separate from each other, or two or more devices may share the same circuitry and/or at least one processor to perform the operations performed by the devices. Suitable devices may include a communication device 302, which itself may include one or more antennas 304, modems, transceiving hardware, etc., for wirelessly communicating with the vehicles; a monitoring device 306, that determines current and/or historical locations of the vehicles, the cargo, and states-of-charge of the power sources; a scheduling device 308, and an energy management system 310. The controller may handle, analyze and disseminate this information on a periodic, aperiodic, or on-demand basis. Optionally, at least some of this information may be input by an operator.

The scheduling device determines which cargo needs to be delivered, where the cargo needs to be delivered, and when the cargo needs to be delivered. The scheduling device may obtain this information from the control systems and/or sensors, from manifests associated with the cargo, and/or from manual input by an operator. In one embodiment, the scheduling device communicates with computing devices of users to receive requests for vehicles. For example, users of mobile phones, tablet computers, or other computers may submit a request for one or more vehicles to travel to a location, couple with a vehicle or a vehicle system (potentially already having a vehicle), and travel with the vehicle or vehicle system to provide additional power to the vehicle or vehicle system. Users may submit requests via signals to the scheduling device to receive vehicles on demand. The requests may identify the location of the vehicle or vehicle system where the vehicle is requested to join, the distance or location to which the requested vehicle is to travel with the vehicle or vehicle system, the routes to be traveled over, and the like. This information may be communicated to the energy management system to determine which vehicle to send.

A suitable energy management system may be the Trip Optimizer system, commercially available from Wabtec Corporation, while a suitable movement planning and dispatch system may be commercially available from Wabtec Corporation under the branding of Train Dispatch System (TDS) and Movement Planner system, among others.

The movement planning system may examine information obtained or otherwise determined by the monitoring device(s), the scheduling device, the manifest (to determine cargo type and amount), various equipment health status systems, network health status systems, route congestion data, weather data, current fuel cost tables, vehicle availability status systems, and the like to determine what cargo should be carried by which cargo vehicles, which of the control, driver-operable and cargo vehicles should couple with the different vehicles to form vehicle systems, which routes that the vehicle systems are to travel along, how far the control vehicles are to stay coupled with the cargo vehicles, where the various vehicles are to swap out of the vehicle systems for other vehicles, where the various energy-storing vehicles are to re-charge the power sources, and the like. The movement planning system may select the control vehicle to include in the various vehicle systems by communicating control signals to the vehicle control systems. These control signals may direct the control vehicle to automatically move to locations where the control vehicle may couple with cargo vehicles and/or driver-operable vehicles to form one or more vehicle systems. Optionally, the control signals may cause the vehicle control systems to present instructions to operators of the control vehicle on where to move the control vehicle to join with the cargo vehicles in the vehicle systems.

The movement planning system may determine what control vehicle are available in the transportation network, where the available control vehicles are located within the transportation network, what other propulsion-generating vehicles are available (and where) in the transportation network, and/or a state of charge of the power sources onboard the control vehicle. Based on this information, the movement planning system may determine which control vehicle are to power the cargo vehicles, whether any propulsion-generating vehicles other than the control vehicle are to help move the cargo vehicles, which stretches or portions of the routes that the different control vehicle are to power the cargo vehicles, and/or which stretches or portions of the routes that other powered driver-operable vehicles are to push or pull the cargo vehicles.

Once the vehicles are selected and the routes plotted, the energy management system may determine the tractive effort needed to move cargo along the routes between various locations 202A-G in the transportation network to get the cargo to the scheduled locations by the scheduled delivery times. For example, the movement planning system may determine that a first control vehicle 102A is to connect with and power the axles of a cargo vehicle 104A from a starting location 202A to a first intermediate location 202C between the starting location 202A and a destination location 202D. The movement planning system may determine that a second control vehicle 102B at a second location 202B is to couple with the cargo vehicle 104A and the first control vehicle 102A to provide additional power to the vehicle system formed from the vehicle 104A, 102B, 104A. This additional power may be used to power the axles of the cargo vehicle 104A and/or to charge power sources of the first control vehicle 102A.

For example, during movement from the location 202B to the location 202C and/or the location 202D, the power sources onboard the second control vehicle 102B may recharge one or more of the power sources onboard the first control vehicle 104A while also powering the axles of the cargo vehicle 104A. Optionally, the second control vehicle 102B may couple with the cargo vehicle 104A and the first control vehicle 104A to receive power from the first control vehicle 104A to charge one or more power sources of the second control vehicle 102B during movement from the location 202B to the location 202C and/or 202D.

The movement planning system may determine that the first control vehicle 104A and/or the second control vehicle 102B are to separate from the vehicle system at a third location 202C while a propulsion-generating driver-operable vehicle 208 (e.g., a locomotive) couples with the cargo vehicle 104A (and optionally the second control vehicle 102B) to propel (e.g., push or pull) the cargo vehicle 104A to the destination location 202D. The movement planning system may determine additional changes of the control vehicle and/or other driver-operable vehicles to join the vehicle system to move the cargo toward the destination location at or before the scheduled arrival time. For example, a variety of different combinations of various vehicles may be used to push, pull, or provide power to the cargo vehicles along trips of the cargo vehicles.

The movement planning system may determine which control vehicle are to couple and move with the cargo vehicles at various locations and/or times during a trip of the cargo vehicle based on states of charge of the control vehicle. In one embodiment, the state of charge of a control vehicle is the amount of electric energy stored in the power sources of the control vehicle. For example, a control vehicle having a full state of charge may have more energy stored onboard the control vehicle than when the control vehicle has half of a state of charge. The movement planning system may examine the locations of the control vehicle and the current states of charge of the control vehicle to determine which of the control vehicle have enough stored energy to power a cargo vehicle over at least part of a trip. Optionally, the state of charge may be an amount of fuel onboard the control vehicle. For example, while the description focuses on a state of charge being monitored, alternatively, the amount of fuel remaining onboard a control vehicle may be monitored.

The movement planning system may strategically change out a control vehicle having a significant amount of stored energy from a vehicle system at a mid-way location during a trip. Similar to the example described above, upon arrival of a first vehicle system at an intermediate location 202B of a trip (between a starting location 202A and a destination location 202D of the trip), a first control vehicle 104A may have enough remaining stored energy to continue powering a first cargo vehicle 104A in the first vehicle system to a further location 202C in the trip or the destination location 202D of the trip. But, the movement planning system may direct the first control vehicle 104A to be decoupled from the first cargo vehicle 104A and removed from the first vehicle system at the intermediate location 202B. Optionally, the movement planning system may direct a second control vehicle 102B to couple with the first cargo vehicle in the first vehicle system at this intermediate location 202B and provide power to the first cargo vehicle 104A toward or to the destination location. The first control vehicle 104A may then fully or at least partially recharge at the intermediate location 202B before coupling with a second cargo vehicle 114B in a second vehicle system.

For example, a charging station 204 may be located at the intermediate location 202B. This charging station may include energy storage devices (e.g., batteries), a connection to an electric utility grid, a connection to another power source (e.g., solar panels, turbine engines, wind turbines, and the like), a power generation system, and the like. The power sources onboard the first control vehicle 104A may connect with the charging station (e.g., using cables) to charge the power sources of the first control vehicle 104A.

This second vehicle system may be moving a second cargo vehicle 114B from another location 202E to the location 202F or 202G through the location 202B. The first control vehicle 104A may couple with the second cargo vehicle 114B at the location 202B and move with the second cargo vehicle 114B to power the axles of the second cargo vehicle 114B to the location 202F and/or the location 202G. Optionally, the movement planning system may direct the first control vehicle 104A to couple with the second cargo vehicle 114B at the location 202B and proceed as the second vehicle system without recharging the first control vehicle 104A or without fully recharging the first control vehicle 104A at the location 202B.

The movement planning system selects which control vehicle to include in various vehicle systems during different trips of cargo vehicles and/or during legs (e.g., portions) of different trips to ensure that the cargo is delivered at a delivery (e.g., destination) location within a designated or pre-selected time slot. This time slot may be a length of time such as a few minutes (e.g., fifteen minutes), hours (e.g., between one and 4 pm), a date, and the like, that the shipper of the cargo has agreed to deliver the cargo and/or that a recipient of the cargo expects to receive the cargo at a destination location. This time slot may be set or selected before departure of the cargo vehicle with the cargo from a starting or origination location of a trip.

The movement planning system may select the control vehicle to provide power to a cargo vehicle, select the locations where the control vehicle couple with and/or hand off the cargo vehicle, and the like, so that the cargo is delivered within the designated time slot, and not before or after the time slot. This may help ensure that portions of the transportation network are not overly congested with vehicle systems delivering cargo too early or too late.

For example, the movement planning system may select control vehicle that are not fully charged to couple with a cargo vehicle responsive to the cargo vehicle being ahead of schedule. The movement planning system may direct the cargo vehicle 104A to remain at the location 202B with a partially charged control vehicle 102B while the power sources onboard the partially charged control vehicle 102B fully or at least partially re-charge. The movement planning system may direct the cargo vehicle 104A to remain in this holding pattern even if the additional charge is not needed for the control vehicle 102B to power the cargo vehicle 104A over the remainder of the trip from the location 202A to the location 202D via the location 202B. As another example, the movement planning system may direct the cargo vehicle 104A to remain at the location 202B even if the additional charge is not needed for the control vehicle 102B to power the cargo vehicle 104A over an upcoming leg of the trip (e.g., the leg extending from the location 202B to the location 202C). This may delay movement of the cargo vehicle along the trip to avoid needlessly adding to the congestion of the transportation network, while ensuring that the cargo arrives within the designated time slot.

The movement planning system may direct a control vehicle to be moved by (or move with) another control vehicle and/or cargo vehicle to another location for charging the control vehicle. For example, the power sources onboard the control vehicle 102C at the location 202C may be depleted of energy or may not have sufficient stored energy to allow the control vehicle 102C to power itself to move to another location (e.g., the location 202B and/or the location 202D). During a trip of the control vehicle 102B from the location 202B to the location 202D through the location 202C (which may involve the control vehicle 102B powering a cargo vehicle), the movement planning system may direct the control vehicle 102B to connect with and push the control 102C, pull the control 102C, and/or provide electric power to the control 102C so that the control 102C moves from the location 202C to the location 202D or the location 202B to recharge the power sources of the control 102C. This may be referred to as the control 102C receiving a “free ride” from the control vehicle 102B to a location where the power sources of the control 102C may be recharged.

The movement planning system optionally may coordinate the concurrent or simultaneous movement of multiple control vehicles in the transportation network to ensure that the proper amount of energy is provided to the cargo vehicles for powering the cargo vehicles to self-propel to the destination locations of the cargo vehicles. This coordination may involve the movement planning system directing one or more control vehicles to couple with a vehicle system on a route between the locations.

For example, the movement planning system may direct a control vehicle to approach a moving vehicle system from behind (e.g., while the control vehicle and the vehicle system are moving in the same direction on a route) and coupling with the vehicle system to join the vehicle system and provide additional energy or fuel to the cargo vehicle(s) in the vehicle system. This coupling may occur while the vehicle system is moving along the route or may occur with the vehicle system stopping on the route for the coupling to occur. As another example, the movement planning system may direct a control vehicle to approach a moving vehicle system from ahead (e.g., while the control vehicle and the vehicle system are moving in opposite directions on a route) and coupling with the vehicle system to join the vehicle system and provide additional energy or fuel to the cargo vehicle(s) in the vehicle system.

The energy management system may determine energy requirements for moving a cargo vehicle between locations during a trip. The energy requirement may be calculated based on vehicle characteristics (e.g., the weight, mass, height, etc.) of the cargo, route characteristics (e.g., the grades and/or curvatures of the routes), schedule characteristics (e.g., the speeds at which the vehicle systems are to travel to arrive at a location within a scheduled time slot, as described above), and the like. For example, the energy management system may calculate that more energy is needed for heavier cargo, taller cargo (e.g., due to wind drag), inclined grades, curved sections of the routes, faster speeds, etc.

The energy management system may calculate that less energy is needed for lighter cargo, shorter cargo, flat or downhill grades, straighter sections of the routes, slower speeds, etc. The movement planning system may then select the control vehicle for including in a vehicle system during different legs (e.g., portions) of a trip with one or more cargo vehicles to ensure that the vehicle system has enough stored energy within the vehicle system over the different legs of the trip. In one embodiment, the energy management system may determine the energy that will be obtained by the control vehicle during movement for charging the power sources. For example, the energy management system may determine the energy that will be gained by the control vehicle from dynamic braking. The amounts of energy gained from dynamic braking may be determined from previous trips of the control vehicle and/or vehicle systems. The energy management system may reduce the calculated amount of energy needed over some legs of a trip by the amount of energy that will be gained (e.g., stored in the power sources) from this dynamic braking.

The movement planning system may determine the times at which control vehicle are to join or leave vehicle systems having at least one cargo vehicle based on charging rates of the control vehicle. For example, the power sources may re-charge with electric energy at speeds that are dictated by the states of charge of the power sources, at speeds that are controlled or limited by the charging stations, and/or at speeds that are based on other factors (e.g., based on loads on the utility grid or system). The movement planning system may determine the times at which control vehicles are to couple or decouple from cargo vehicles based on the charging rates so that the cargo vehicles are not waiting at a location of a control vehicle while the control vehicle charges to a state needed to complete the next leg of a trip.

Movements of vehicle systems may coordinate with each other so that the vehicle systems may share stored power with each other. For example, multiple vehicle systems may be scheduled to travel in the same direction on the same route (and optionally to remain no farther than a designated distance from each other) so that a control vehicle of one vehicle system may decouple from that vehicle system. This control vehicle may then couple to and then accelerate or decelerate to move to another vehicle system. This may occur for the control vehicle to provide additional energy to the other driver-operable vehicle system.

The movement planning system may determine which routes are uni-directional routes and which routes are bi-directional routes and create schedules based on this determination. A uni-directional route is a route on which only a single vehicle or vehicle system may travel at a time, such as a single track of a rail network. A bi-directional route is a route on which two vehicles or vehicle systems may travel, such as parallel tracks of a rail network, different lanes of a road, and the like.

The movement planning system may consider whether to hand off cargo carried by a vehicle system to another type or category of vehicles. For example, the movement planning system may determine that a vehicle system may carry the cargo to a meet-up location that is within a designated distance of a final destination or delivery location of the cargo (e.g., within one mile). The movement planning system may communicate a signal to another vehicle (e.g., a driver-operable car, delivery truck, etc.) and provide a meet-up location or may direct the driver-operable vehicle to travel to the meet-up location and deliver or receive the cargo. The vehicle system may hand-off or otherwise transfer the cargo to the driver-operable vehicle at the meet-up location for the driver-operable vehicle to carry and deliver the cargo the last remaining distance to the final destination or delivery location.

The movement planning system may determine and use the bandwidth capacities of locations in creating the schedules. For example, the movement planning system may determine how many control vehicles and/or cargo vehicles may remain at a location and create the schedules so that no more vehicles than the capacity of the location are held at that location at any time. The devices may store some or all of this information in a tangible and non-transitory computer readable medium, such as a computer memory 312.

The time needed for control vehicle to travel between locations may be determined and used by the movement planning system in creating schedules for the vehicles. For example, if a control vehicle is needed at another location from a current location of the control vehicle, the movement planning system may factor in the transit time needed for the control vehicle to travel to the other location in creating the schedule. This may involve the movement planning system delaying arrival of the cargo vehicle at the other location until the control vehicle arrives at the other location and/or is charged to at least a selected or designated state of charge.

Another characteristic of the routes that may be considered by the movement planning system in creating the schedules is the quality of the routes, such as the smoothness or roughness of the routes. For example, if a cargo vehicle is to transport a cargo that is fragile or susceptible to damage during travel over a rougher route, the movement planning system may create a schedule for the cargo that avoids or reduces the distance traveled on a rough route (to the extent possible).

But, if a cargo vehicle and/or control vehicle are to travel to a location without transporting cargo or while transporting cargo that is not fragile or susceptible to damage, the movement planning system may schedule the vehicle to travel over the rougher routes to arrive at the location on time. The movement planning system optionally may determine upper speed limits that differ from designated speed limits of the routes. For example, the energy management system may direct a vehicle system to travel slower than a route speed limit to reduce the shock and vibrations imparted on the cargo being carried by the vehicle system on a rougher route.

The design of the vehicles may be used in a scalable network of assets that are strategically positioned throughout the transportation network where a network effort of charge capability and traveling range extension may exist as the number of vehicles increases. As described above, the vehicles are designed to charge and re-charge as individual assets on designated charging networks or stations positioned throughout the network. These stations may be automated in that the vehicles may pull up to a station being charging the power sources via a wireless and/or automatically wired connection (e.g., a connector on the vehicle may be located such that the connector mates with a corresponding connector of the station as the vehicle moves close to the station).

A vehicle system having at least one vehicle and at least one vehicle may pull up to a charging station and the vehicle(s) may disconnect from the vehicle(s). The vehicle(s) may then begin charging the power sources onboard the vehicle(s). The vehicle(s) may then self-propel to another vehicle or vehicles at the station that have power sources already at least partially charged. The vehicle(s) may couple with the driver-operable vehicle(s) to form another vehicle system, which may depart from the station while the original or previous control vehicle(s) remains at the station to charge the power sources. This allows the cargo to keep moving in the network without having to wait for the an original control vehicle(s) to recharge.

A charging network (formed of plural charging stations) may include a mobile charging vehicle 210 that may be deployed to vehicles at locations other than charging stations. The mobile charging vehicle may be another vehicle having onboard power sources. The mobile charging vehicle may move to the location of the vehicle, connect with the vehicle (using wired and/or wireless connections), and transfer electric energy from the power sources onboard the mobile charging vehicle.

Optionally, the movement planning system may direct the vehicles to move within the network based on two or more vehicles exchanging energy to charge power sources outside of the charging stations. The energy management system may examine the terrain and/or routes being traveled by a first vehicle and direct one or more second vehicles to couple with the first vehicle to share power between the first and second vehicle(s). For example, if a first vehicle is traveling toward a location where half the terrain over which the first vehicle will travel is downhill and/or will involve braking, the energy management system may send signals to one or more other second vehicles in need of charging of power sources onboard the second vehicles. These signals may direct the second vehicles to travel to and couple with the first vehicle. The controller onboard the first vehicle may then direct the power sources on the first vehicle to provide at least some stored energy to the power sources on the second vehicle(s). Similarly, the movement planning system may direct a vehicle to meet and couple with another vehicle or vehicle system to help provide additional power as requested or needed.

This sort of management of mobile charging sources may reduce the need for fixed location charging stations. For example, because the vehicles may themselves be charging stations that may move throughout the network, fewer stationary charging stations may be needed while meeting the energy demands of the vehicle systems traveling in the network.

In one embodiment, one or more of the charging stations may inductively charge the power sources onboard vehicles as the vehicles move through or near the charging station. For example, the charging station may have coils positioned in the route or in other locations where the power sources onboard a vehicle may be inductively charged. Such as charging station may be positioned in an area of reduced speed limits (e.g., in an urban area already having slower speed limits, near intersections with other routes, and the like) so that the vehicles that already are moving slowly may benefit from the slower movement by at least partially inductively charging power sources of the vehicles.

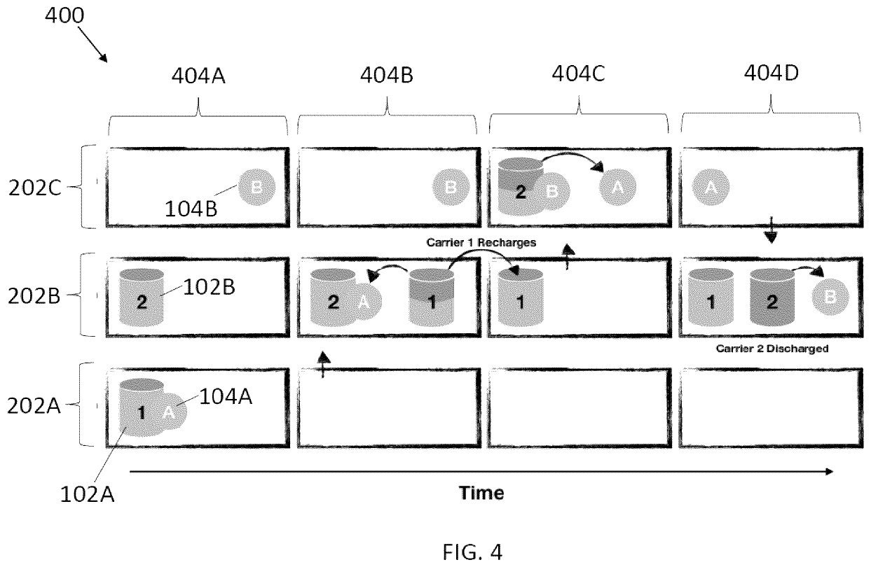

FIG. 4 illustrates one example of a movement schedule 400 generated by the movement planning system. This movement schedule is shown as a grid or matrix with each row representing a different location in the transportation network and each column representing a different scheduled time 404A-D. In the illustrated example, the locations are locations 202A, 202B, 202C, but optionally may be other locations in the transportation network. The scheduled times 404 are shown as scheduled times 404A-D, with the time 404A occurring before the time 404B, which occurs before the time 404C, which occurs before the time 404D.

The schedule 400 is established to move a first cargo (“A” in FIG. 4) from the first location 202A to the third location 202C in the transportation network and to move a second cargo (“B” in FIG. 4) from the third location 202C to the second location 202B in the transportation network. The first cargo may be referred to as the 116A and the second cargo may be referred to as the 116B. In this example, the locations 202A, 202B are the same distance apart from each other as the locations 202B, 202C. As a result, the time needed for a vehicle system formed by a single control vehicle and a single cargo vehicle (carrying cargo 116A or 116B) to travel from the location 202A to the location 202B is the same as each of (a) the time needed for the vehicle system to travel from the location 202B to the location 202C, (b) the time needed for the vehicle system to travel from the location 202C to the location 202B, and (c) the time needed for the vehicle system to travel from the location 202B to the location 202A.

Additionally, in the illustrated example, the amount of electric energy or fuel required to propel a vehicle system formed from one control vehicle and one cargo vehicle to move (a) from the location 202A to the location 202C, (b) from the location 202B to the location 202A or 202C and then back to the location 202B, (c) from the location 202C to the location 202B and then back to the location 202B, and so on, fully depletes the energy or fuel stored in the control vehicle having power sources 701 that are fully charged or full of fuel before beginning the trip.

The movement planning system may determine that it takes one hour for a vehicle system formed from a single control vehicle and a single cargo vehicle between any two neighboring locations (e.g., locations that are not separated from each other by another location) is one hour. The movement planning system may be notified (e.g., from an operator, from a pre-existing delivery schedule, from a manifest document, etc.) that the 116A is to be delivered to the location 202C (from the location 202A) in about (e.g., within 10%) two hours and the 116B is to be delivered to the location 202B (from the location 202C) in about three hours. The movement planning system also may be instructed or have a default requirement that at least one of the control vehicles be fully charged or full of fuel at the completion of delivery of the cargo 116A, 116B for delivery of additional cargo.

Based on the locations of the cargo 116A, 116B and the control vehicle, the movement planning system determines that an optimal schedule for delivery of the cargo 116A, 116B involves a cargo switch at location 202B. Specifically, at the first time 404A, a fully charged first control vehicle 104A connects with and powers a first cargo vehicle 104A (having the 116A onboard) in a first vehicle system at the location 202A, a fully charged second control vehicle 102B is located at the location 202B, and a second cargo vehicle 114B (having the 116B onboard) is located at the location 202C. While the first control vehicle 104A has enough stored energy to power the first cargo vehicle 104A to take the 116A all the way to the scheduled destination location.

But, doing this would incur the cost of charging or re-fueling the first control vehicle 104A at the location 202C. This would result in the 116B not being delivered to the location 202C on time. Instead, the movement planning system directs the first control vehicle 104A to power the first cargo vehicle 104A to take the 116A from the location 202A to the location 202B (at time 404B, which is one hour after starting movement).

The first control vehicle 104A then separates from the first cargo vehicle 104A having the 116A at the location 202B and the second control vehicle 102B couples with the first cargo vehicle 104A. The second control vehicle 102B then powers the first cargo vehicle 104A to take the 116A from the location 202B to the location 202C from the time 404B to the time 404C to complete delivery of the 116A. The power sources onboard the first control vehicle 104A fully recharge or re-fuel during the time between the times 404B, 404C (while the second control vehicle 102B completes delivery of the 116A).

The second control vehicle 102B has half-charged or half depleted power sources at the time 404C when the second control vehicle 102B couples with the second cargo vehicle 114B. The second control vehicle 102B then powers the second cargo vehicle 114B to take the second 116B to the location 202B from the time 404C to the time 404D. The second control vehicle 102B then arrives at the location 202B at or around the time 404D to deliver the 116B at the location 202B. Additionally, the first control vehicle 104A has fully charged or fully fueled power sources, as required.

The movement planning system may schedule concurrent movements of different types of vehicle systems through the route network based at least in part on route capacities, expected vehicle speeds, cargo types, and the like. Different lengths of routes may be able to hold different lengths of vehicle systems based on a variety of factors, including the type of vehicle system (e.g., rail vehicle system that includes locomotives versus vehicle systems having the banker vehicle and cargo vehicle). For example, heavier rail vehicle systems may require longer distances to stop or slow along a route in the event of an emergency (or other) brake application. But, a vehicle system formed from one or more control vehicle and optionally one or more cargo vehicles may require significantly shorter distances to stop (e.g., less than half the stopping distance) or slow to a designated speed. The movement planning system may direct such a vehicle system to travel ahead of or behind a rail vehicle system while the rail vehicle system moves to occupy more of the route than could be occupied by multiple rail vehicle systems. This may allow for the vehicle systems to be ingested into the flow of traffic within the transportation network without disrupting this flow of traffic. For example, a vehicle system may travel within the stopping distance of a moving rail vehicle system because the vehicle system may be able to stop or slow before the rail vehicle system. In contrast, one rail vehicle system may not be able to travel within the stopping distance of another moving rail vehicle system because either rail vehicle system may not be able to slow in time to avoid colliding with the other rail vehicle system if an emergency or other brake application occurs. Scheduling or directing the vehicle systems to travel within the stopping distances of driver-operable vehicle systems may allow for more cargo to travel on the routes of the transportation network and may further increase the efficiency by which cargo is delivered. The vehicle systems may be introduced into the transportation network with the ability for the vehicle systems to follow or trail existing rail vehicle systems at close proximities based on the dynamically changing stopping distances. This allows for the vehicle systems to travel within the moving blocks of the rail vehicle systems, thereby utilizing more transportation network capacity to move goods without disruption of the movement of the rail vehicle systems in the same network. Priorities may be assigned to the vehicle systems based on the cargo being transported to determine where and/or when the various vehicle systems may be ingested into the spaces between the rail vehicle systems traveling in the network.

The management systems described herein also may be used to move individual and/or groups of passengers on demand between locations based on overlapping portions of the routes that are to be traveled by the passengers. For example, several vehicles and/or vehicle systems may be moving in the transportation network. A first passenger at or near the location 202B may wish to call a vehicle or vehicle system to travel to the location 202C. The first passenger may input a request for a vehicle or vehicle system to the scheduling device or the monitoring device. The scheduling device or the monitoring device receives this request and provides the information (e.g., the location where the first passenger is requesting to be picked up, the time at which a ride is requested, the location to which the first passenger wants to travel, etc.) to the movement planning system. The movement planning system may determine current locations of vehicles and/or vehicle systems moving in the network, and select a vehicle or vehicle system that will be traveling from the location 202B to the location 202C at or near the time at which the first passenger wants to travel between these locations. The selected vehicle or vehicle system may already be transporting one or more other passengers. For example, the selected vehicle or vehicle system may have a second passenger onboard that is traveling from the location 202F to the location 202D via the locations 202B, 202C. The movement planning system may send a signal to the selected vehicle or vehicle system and direct the vehicle or vehicle system to stop and pick up the first passenger at or near the location 202B.

For vehicles that are able to travel on different types of terrain (as described herein), the selected vehicle may travel to a location near the first passenger on a first type of route (e.g., a railroad track), move off the first type of route, and travel to the location of the first passenger on a different, second type of route (e.g., roads). Optionally, the management system may coordinate passenger travel with other transportation systems. For example, responsive to receiving the request from the first passenger, the scheduling device may communicate with another transportation system (e.g., a taxi dispatch center, a ridesharing service, etc.) and automatically request that this other transportation system send a vehicle (e.g., a car) to transport the first passenger to the location 202B (so that the selected vehicle or vehicle system may pick up the passenger). The scheduling device also may request that this other transportation system provide a vehicle (e.g., another car) to transport the passenger from the location 202C to a final destination location of the trip of the first passenger (if the location 202C is not the final destination). The first passenger may then get a ride to the location 202C as the selected vehicle or vehicle system travels through the location 202C toward the location 202D for the second passenger.

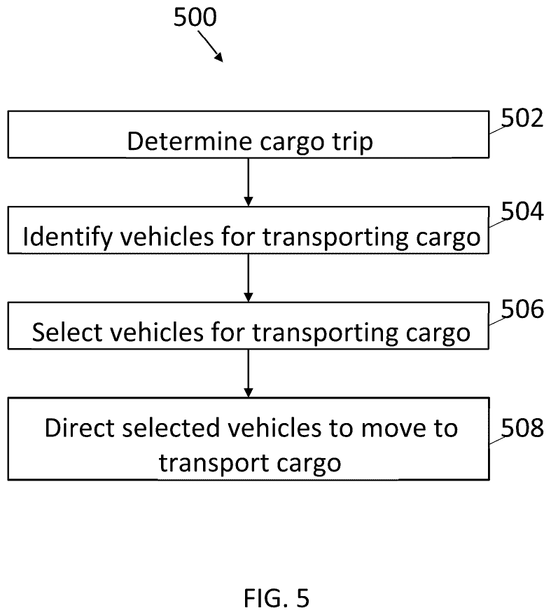

FIG. 5 illustrates a flowchart of one embodiment of a method 500 for managing movements of vehicles in a transportation network to provide for delivery of cargo. The method represents a version of operations or algorithm(s) performable by the management system to determine how or where to move control vehicle and/or cargo vehicles in a transportation network to ensure that cargo is delivered on time (e.g., within designated times or time slots).

At step 502, a trip plan for the cargo may be determined. This trip plan or trip may be determined at least in part by one or more cargo delivery requirements received by the system. The cargo delivery requirements may dictate which cargo is to be delivered, where the cargo is located, the location to where the cargo is to be delivered, and when the cargo is to be delivered (e.g., designated time slots for delivery of the cargo). Additional delivery requirements may include restrictions on which routes may be traveled during delivery of the cargo. Some cargo may be too fragile or susceptible to damage to travel on some routes and some cargo may contain hazardous material that is not legally permitted to travel on some portions of routes. The cargo delivery requirements may be input into the scheduling device or the monitoring device via a user interface (e.g., a keyboard, touchscreen, microphone, etc.), may be obtained from one or more trip manifests or delivery contracts, and the like.

At step 504, the availability of one or more control vehicle and/or cargo vehicles in the transportation network is determined. The locations of the vehicles may be determined by the vehicle control systems onboard the control vehicle communicating locations of the control vehicle to the monitoring device via the communication device. The state of charge of one or more of the vehicles also may be determined. As described above, the vehicle control systems may communicate the states of charge of the control vehicle to the monitoring device.

At step 506, one or more vehicles are selected for delivering the cargo. The energy management system or the movement planning system may select one or more control vehicle to provide power to one or more cargo vehicles to move the cargo in the network to a destination or delivery location of the cargo. The selection of the vehicles may be determined or based at least in part on locations of the vehicles, states of charge of the power sources onboard the vehicles, the amount of energy needed to power the vehicle transporting the cargo over the entire trip and/or segments of the trip, the locations of charging stations, the locations and availabilities of mobile charging vehicles other cargo being moved on driver-operable vehicles in the network, etc.

At step 508, the control vehicle(s) and/or cargo vehicle(s) selected for delivery of the cargo are directed to move in the transportation network to deliver the cargo. For example, the movement planning system may send signals to the vehicles to couple with the vehicle(s) carrying the cargo and power the vehicle(s) to deliver the cargo. As described above, the movement planning system may instruct vehicles to be swapped out during the trip, may direct the mobile charging vehicles to charge driver-operable vehicles en route and/or be charged by driver-operable vehicles en route, combine with different vehicle systems, and the like.

In one embodiment, the controllers or systems described herein may have a local data collection system deployed and may use machine learning to enable derivation-based learning outcomes. Further, the controller may have sufficient computing power to perform edge computing functions. The controllers may learn from and make decisions on a set of data (including data provided by the various sensors) by making data-driven predictions and adapting according to the set of data. In embodiments, machine learning may involve performing a plurality of machine learning tasks by machine learning systems, such as supervised learning, unsupervised learning, and reinforcement learning. Supervised learning may include presenting a set of example inputs and desired outputs to the machine learning systems. Unsupervised learning may include the learning algorithm structuring its input by methods such as pattern detection and/or feature learning. Reinforcement learning may include the machine learning systems performing in a dynamic environment and then providing feedback about correct and incorrect decisions. In examples, machine learning may include a plurality of other tasks based on an output of the machine learning system. In examples, the tasks may be machine learning problems such as classification, regression, clustering, density estimation, dimensionality reduction, anomaly detection, and the like. In examples, machine learning may include a plurality of mathematical and statistical techniques. In examples, the many types of machine learning algorithms may include decision tree based learning, association rule learning, deep learning, artificial neural networks, genetic learning algorithms, inductive logic programming, support vector machines (SVMs), Bayesian network, reinforcement learning, representation learning, rule-based machine learning, sparse dictionary learning, similarity and metric learning, learning classifier systems (LCS), logistic regression, random forest, K-Means, gradient boost, K-nearest neighbors (KNN), a priori algorithms, and the like. In embodiments, certain machine learning algorithms may be used (e.g., for solving both constrained and unconstrained optimization problems that may be based on natural selection). In an example, the algorithm may be used to address problems of mixed integer programming, where some components restricted to being integer-valued. Algorithms and machine learning techniques and systems may be used in computational intelligence systems, computer vision, Natural Language Processing (NLP), recommender systems, reinforcement learning, building graphical models, and the like. In an example, machine learning may be used making determinations, calculations, comparisons and behavior analytics, and the like.

In one embodiment, the controllers may include a policy engine that may apply one or more policies. These policies may be based at least in part on characteristics of a given item of equipment or environment. With respect to control policies, a neural network can receive input of a number of environmental and task-related parameters. These parameters may include, for example, operational input regarding operating equipment, data from various sensors, location and/or position data, and the like. The neural network can be trained to generate an output based on these inputs, with the output representing an action or sequence of actions that the equipment or system should take to accomplish the goal of the operation. During operation of one embodiment, a determination can occur by processing the inputs through the parameters of the neural network to generate a value at the output node designating that action as the desired action. This action may translate into a signal that causes the vehicle to operate. This may be accomplished via back-propagation, feed forward processes, closed loop feedback, or open loop feedback. Alternatively, rather than using backpropagation, the machine learning system of the controller may use evolution strategies and techniques to tune various parameters of the artificial neural network. The controller may use neural network architectures with functions that may not always be solvable using backpropagation, for example functions that are non-convex. In one embodiment, the neural network has a set of parameters representing weights of its node connections. A number of copies of this network are generated and then different adjustments to the parameters are made, and simulations are done. Once the output from the various models has been obtained, it may be evaluated on their performance using a determined success metric. The best model is selected, and the vehicle controller executes that plan to achieve the desired input data to mirror the predicted best outcome scenario. Additionally, the success metric may be a combination of the optimized outcomes, which may be weighed relative to each other. Determining steps may be accomplished on-board, via an edge device, or remotely through a back-office arrangement.

In one embodiment, a control vehicle includes a propulsion system having one or more onboard power sources that can generate or store energy for powering the propulsion system and a control system that can control the propulsion system for movement along one or more routes. The controller can direct the propulsion system to move the control vehicle to a location of a cargo vehicle and to provide at least some of the energy that is stored to the cargo vehicle for powering the cargo vehicle to self-propel for delivery of cargo onboard the cargo vehicle.

Optionally, the propulsion system includes one or more powered axles that move the control vehicle along one or more land-based routes. Optionally, the propulsion system includes fewer powered axles than the cargo vehicle. Optionally, the control vehicle is smaller and lighter than the cargo vehicle. Optionally, the control system can automatically control the movement of the control vehicle according to signals received from one or more of an off-board transportation management network system, another control vehicle, or wayside equipment. Optionally, the control system can automatically control the movement of the control vehicle according to signals received from one or more sensors onboard the control vehicle. Optionally, the propulsion system can generate the propulsion to move the control vehicle along one or more tracks as a rail vehicle. Optionally, the propulsion system can generate the propulsion to move the control vehicle along one or more roads. Optionally, the propulsion system can generate the propulsion to move the control vehicle along one or more water routes tracks as a marine vessel. Optionally, the propulsion system is a multi-terrain system that can propel the control vehicle along two or more different categories of routes. Optionally, the two or more different categories of routes include two or more of: railroad tracks, roads, or water routes.

Optionally, the system also includes an unmanned aerial vehicle that can decouple from the control vehicle, fly away from the control vehicle, obtain one or more images or videos outside of the control vehicle, and to communicate the one or more images or videos to the control system. The control system can use the one or more images or videos to automatically change the movement of the control vehicle. Optionally, the one or more power sources are one or more batteries. Optionally, the system also includes a coupler that can mate with the cargo vehicle to supply at least some of the energy stored in the one or more power sources to the cargo vehicle power propulsion of the cargo vehicle.

In one embodiment, a cargo vehicle includes one or more of a platform or an enclosure that can carry cargo, one or more propulsion systems that can propel the one or more of the platform or the enclosure, and a connector that can couple with a control vehicle. The connector can conductively couple the one or more propulsion systems with a power source onboard the control vehicle to draw energy from the power source to power the one or more propulsion systems. The one or more propulsion systems do not have access to sufficient energy to propel the one or more of the platform or the enclosure to a delivery location of the cargo without the energy from the control vehicle. Optionally, the one or more propulsion systems can generate more propulsive force than the control vehicle.

In one embodiment, a transportation network management system includes a monitoring device that can determine locations of control vehicles in a transportation network formed from interconnected routes. The monitoring device can determine states of charge of power sources disposed onboard the control vehicle. The system also includes a scheduling device that can determine delivery details of cargo. The delivery details include a delivery location of the cargo. The system may include a movement planning system that can direct at least one of the control vehicle to self-propel to a cargo vehicle, couple with the cargo vehicle, and supply power from at least one of the power sources onboard the at least one control vehicle to power the cargo vehicle for transportation of the cargo to the delivery location.

Optionally, the movement planning system can direct a first control vehicle of the control vehicle to travel to the cargo vehicle, couple with the cargo vehicle, power the cargo vehicle to a first location, and then separate from the cargo vehicle, the movement planning system can direct a second control vehicle of the control vehicle to couple with the cargo vehicle at the first location and power the cargo vehicle to travel toward the delivery location of the cargo. Optionally, the movement planning system can direct the first control vehicle to separate from the cargo vehicle to recharge at least one of the power sources onboard the first control vehicle and before the power sources onboard the first control vehicle are depleted of stored energy. Optionally, the movement planning system can direct a third control vehicle to meet up with and transfer energy to at least one of the first control vehicle or the second control vehicle during movement toward the delivery location. Optionally, the movement planning system can direct a third control vehicle to meet up with and transfer energy from at least one of the first control vehicle or the second control vehicle during movement toward the delivery location. Optionally, the movement planning system can identify a meet-up location that is within a designated distance of the delivery location and to direct another vehicle to meet with the cargo vehicle at the meet-up location, obtain the cargo from the cargo vehicle, and deliver the cargo to the delivery location. Optionally, the movement planning system can identify space between rail vehicle systems moving in the transportation network for one or more of the control vehicle and one or more of the cargo vehicles to travel to be ingested into flow of traffic in the transportation network. Optionally, the movement planning system can identify where the control vehicle and plural instances of the cargo vehicle are to travel based on relative priorities of the cargo vehicles.

As used herein, the terms “processor” and “computer,” and related terms, e.g., “processing device,” “computing device,” and “controller” are not limited to just those integrated circuits referred to in the art as a computer, but refer also to a microcontroller, a microcomputer, a programmable logic controller (PLC), field programmable gate array, and application specific integrated circuit, and other programmable circuits. Suitable memory may include, for example, a computer-readable medium. A computer-readable medium may be, for example, a random-access memory (RAM), a computer-readable non-volatile medium, such as a flash memory. The term “non-transitory computer-readable media” represents a tangible computer-based device implemented for short-term and long-term storage of information, such as, computer-readable instructions, data structures, program modules and sub-modules, or other data in any device. Therefore, the methods described herein may be encoded as executable instructions embodied in a tangible, non-transitory, computer-readable medium, including, without limitation, a storage device and/or a memory device. Such instructions, when executed by a processor, cause the processor to perform at least a portion of the methods described herein. As such, the term includes tangible, computer-readable media, including, without limitation, non-transitory computer storage devices, including without limitation, volatile and non-volatile media, and removable and non-removable media such as firmware, physical and virtual storage, CD-ROMS, DVDs, and other digital sources, such as a network or the Internet.

The singular forms “a”, “an”, and “the” include plural references unless the context clearly dictates otherwise. “Optional” or “optionally” means that the subsequently described event or circumstance may or may not occur, and that the description may include instances where the event occurs and instances where it does not. Approximating language, as used herein throughout the specification and claims, may be applied to modify any quantitative representation that could permissibly vary without resulting in a change in the basic function to which it may be related. Accordingly, a value modified by a term or terms, such as “about,” “substantially,” and “approximately,” may be not to be limited to the precise value specified. In at least some instances, the approximating language may correspond to the precision of an instrument for measuring the value. Here and throughout the specification and claims, range limitations may be combined and/or interchanged, such ranges may be identified and include all the sub-ranges contained therein unless context or language indicates otherwise.

This written description uses examples to disclose the embodiments, including the best mode, and to enable a person of ordinary skill in the art to practice the embodiments, including making and using any devices or systems and performing any incorporated methods. The claims define the patentable scope of the disclosure, and include other examples that occur to those of ordinary skill in the art. Such other examples are intended to be within the scope of the claims if they have structural elements that do not differ from the literal language of the claims, or if they include equivalent structural elements with insubstantial differences from the literal language of the claims.

1. A vehicle system, comprising an unoccupied control vehicle with no onboard driver and having:
a first propulsion system configured to propel the control vehicle along a route, and optionally to stop or slow the control vehicle;
one or more onboard power sources configured to generate, store or both generate and store energy for powering at least the first propulsion system; and
a controller having one or more processors and that is configured to autonomously control the first propulsion system to move the control vehicle along one or more routes, and to interface with and couple to a driver-operable vehicle that has a second propulsion system, and the controller is configured further to obtain control over the second propulsion system while the control vehicle is interfaced and coupled with the driver-operable vehicle.

2. The vehicle system of claim 1, wherein the controller is configured further to interface with a positive vehicle control system, and the driver-operable vehicle is not equipped to interface with the positive vehicle control system except through the controller.

3. The vehicle system of claim 2, wherein the positive vehicle control system is a positive train control (PTC) system and obtaining control over the second propulsion system comprises switching from one operating mode to another operating mode.

4. The vehicle system of claim 1, wherein the controller is configured to automatically control movement of the control vehicle according to signals received from one or more of an off-board transportation management network system, another control vehicle, or wayside equipment.

5. The vehicle system of claim 1, wherein the controller is configured to automatically control movement of the control vehicle based at least in part on signals received from one or more sensors onboard the control vehicle.

6. The vehicle system of claim 1, wherein the controller is configured to automatically control movement of the control vehicle based at least in part on signals received from one or more sensors offboard the control vehicle.

7. The vehicle system of claim 6, the one or more sensors are disposed in a wayside device that is disposed at a crossing between the route and another route; and
the controller is configured further to respond to a determination that an obstacle is present in the crossing.

8. The vehicle system of claim 1, wherein the control vehicle is a multi-terrain system configured to propel the control vehicle along two or more different categories of routes, and the controller is configured further to switch operating modes from a track capable operating mode to road capable operating mode.

9. The vehicle system of claim 1, further comprising at least one sensor in communication with the controller that is configured to inspect at least a portion of the route as the vehicle system traverse the route.

10. The vehicle system of claim 1, further comprising a coupler configured to automatically couple and decouple with one or more of a cargo vehicle, the driver-operable vehicle, and another control vehicle.

11. The vehicle system of claim 1, wherein the controller is configured further to control an engine onboard the driver-operable vehicle, and such control includes increased and decreasing a throttle of the engine, and, optionally, starting and stopping the engine.

12. The vehicle system of claim 1, wherein the controller is configured further to control a braking system on the driver-operable vehicle, whereby one or more traction motors on the driver-operable vehicle are set to a dynamic braking mode to brake the vehicle system and to generate electricity from the traction motors and supply such generated electricity to a resistor grid, a battery bank, or both a resistor grind and a battery bank.

13. The vehicle system of claim 1, wherein the controller is configured further to control the driver-operable vehicle to one or more of: sand the route and thereby to increase its tractive effort, to annunciate by activating its horn, and drag charge a battery on the control vehicle.

14. A vehicle system, comprising:
a controller disposed on a control vehicle and having one or more processors that are configured to:
obtain at least one first operating parameter from a first sensor related to an operating system of a driver-operable vehicle;
compare the at least one first operating parameter to an expected first operating parameter;
determine an operating condition of the operating system based at least in part on the first operating parameter;
in response to the at least one first operating parameter exceeding a determined threshold value related to the expected first operating parameter obtain at least one auxiliary operating parameter from a second sensor that is offboard the driver operable vehicle, wherein the auxiliary operating parameter relates to the operating condition; and
verify the operating condition based at least in part on the first operating parameter and on the auxiliary operating parameter; wherein
the controller is further configured to control movement of the driver-operable vehicle responsive to verifying the operating condition of the operating system by changing one or more of a propulsion setting or a brake setting of the driver-operable vehicle.

15. The vehicle system of claim 14, wherein the controller is configured further to communicate with one or more of a positive vehicle control system, a wireless crossing wayside device, a signaling system, and a vehicle network management system; and
the controller is further configured to control movement of the vehicle system in response to signals from one or more of the positive vehicle control system, the wireless crossing wayside device, the signaling system, and the vehicle network management system.

16. The vehicle system of claim 14, wherein the controller is configured further to determine a trip plan for the vehicle system to travel over a route, and to control the driver-operable vehicle to provide propulsion to the vehicle system according to the trip plan.

17. The vehicle system of claim 16, wherein the controller is configured further to control the vehicle system to traverse the route at a speed that is less than a maximum speed limit, wherein the maximum speed limit differs at locations along the route.

18. A controller for a vehicle system that is disposed on a control vehicle having an auxiliary sensor, the controller having one or more processors configured to:
compare at least one first operating parameter of a driver-operable vehicle to an expected first operating parameter;
initiating the auxiliary sensor to detect at least one auxiliary operating parameter responsive to determining that the at least one first operating parameter exceeds a determined threshold value related to the expected first operating parameter; and
verify an operating condition of the driver-operable vehicle based on both the first operating parameter and the auxiliary operating parameter, wherein
the controller is configured further to change one or more operating settings of the vehicle system to control movement of the vehicle system responsive to verifying the operating condition of the driver-operable vehicle.

19. The vehicle system of claim 18, wherein change of the one or more operating settings comprises changing one or more of a propulsion setting or a brake setting of the driver-operable vehicle.

20. The vehicle system of claim 18, wherein the controller is configured further to direct the control vehicle to actuate a coupler and uncouple itself from the vehicle system.
